(19) United States
(12) Patent Application Publication
(10) Pub. No.: US 2026/0015504 A1
(43) Pub. Date: Jan. 15, 2026

(54) EXTRACTS OF COAL AND USES THEREOF

(71) Applicant: UNIVERSITY OF WYOMING, Laramie, WY (US)

(72) Inventors: Jeramie J. ADAMS, Laramie, WY (US); Wyatt J. PHILLIPS, Laramie, WY (US); Louis C. MULLER, Laramie, WY (US); Joseph Montgomery AULT, Laramie, WY (US); Alex Mitchell LITERATI, Laramie, WY (US)

(21) Appl. No.: 18/994,417

(22) PCT Filed: Jul. 13, 2023
(86) PCT No.: PCT/US2023/027670

§ 371 Date: Jan. 14, 2025

Related U.S. Application Data
(60) Provisional application No. 63/389,088, filed on Jul. 14, 2022.
(60) Provisional application No. 63/407,518, filed on Sep. 16, 2022.

(51) Int. Cl. C08L 95/00; C09D 7/65; C09D 195/00; C09J 11/08; C09J 195/00; C09K 3/10

(52) U.S. Cl. CPC C08L 95/00; C09D 7/65; C09D 195/00; C09J 11/08; C09J 195/00; C09K 3/10; C08L 2207/322; C09K 2200/069

(57) ABSTRACT

Embodiments of the present disclosure generally relate to extracts of coal, compositions thereof, and uses thereof. Embodiments of the present disclosure also generally relate to processes for extracting coal. In an embodiment is provided a composition that includes a C4 to C28 alcohol extract of coal. In another embodiment, compositions that include a C4 to C28 alcohol extract of coal are utilized in blends, pavement formulations, crack sealants, shingle coatings, adhesives, fuels, and asphalt or bitumen compositions that resist flow at ambient temperature. In another embodiment, compositions that include a C4 to C28 alcohol extract of coal are converted to a reaction product, where the reaction product is utilized in a pavement formulation or an anti-stripping agent.

### BACKGROUND

### Field

Embodiments of the present disclosure generally relate to extracts of coal, compositions thereof, and uses thereof. Embodiments of the present disclosure also generally relate to processes for extracting coal.

### Description of the Related Art

Coal is utilized in industry as both a fuel and as a source of chemicals. Such fuels and chemicals are produced from coal by coal liquefaction or solvent extraction. Conventional technologies for coal liquefaction and solvent extraction rely on tetralin or aromatic oils to react with the coal macrostructure to break it down into smaller molecules. These solvents are produced from petroleum, are carcinogenic, and in the case of tetralin, are very expensive. Other technologies for coal liquefaction and solvent extraction are inefficient and costly, as they utilize catalysts and hydrogen at high temperatures and/or high pressures, well within the pyrolysis regime, to improve the conversion.

In addition, coal is becoming increasingly attractive as an alternative to petroleum for use in the manufacture of intermediate, derivative, and finished high value products such as asphalt, among others. Because carbon dioxide is generated by both crude oil production, and from the fact that asphalt is a byproduct after removing very large amounts of fuel fractions which are combusted and turned into carbon dioxide during the asphalt production process itself, asphalt production is currently a leading source of current carbon dioxide emissions for asphalt pavements. As climate change becomes an increasing problem and the desire to reduce carbon dioxide gas emissions (a principal cause of climate change) continues, the asphalt production industry and other industries must become more efficient and less environmentally hazardous. Overall, improved coal extraction processes to achieve new high-value, non-hazardous and low-carbon intensity asphalt products is needed.

There is a need for new and improved extracts of coal and for methods of extracting coal. There is also a need to utilize higher amounts of coal for higher value products.

### SUMMARY

Embodiments of the present disclosure generally relate to extracts of coal, compositions thereof, and uses thereof. Embodiments of the present disclosure also generally relate to processes for extracting coal.

In an embodiment is provided a composition that includes a C4 to C28 alcohol extract of coal. Implementations may include one or more of the following. The C4 to C28 alcohol can include a linear or branched, saturated or unsaturated, cyclic or acyclic, aromatic or nonaromatic C4 to C28 alcohol. The lauryl alcohol, myristyl alcohol, stearyl alcohol, cetyl alcohol, oleyl alcohol, linoleic alcohol, isostearyl alcohol, cardanol, or combinations thereof. The C4 to C28 extract of coal can be at least partially vacuum distilled. The composition can further include a polymer derived from a C4 to C28 alcohol monomer. The polymer can include an ether. The polymer can include a dimer, the dimer comprising an ether. The C4 to C28 alcohol monomer can include an internal olefin. The C4 to C28 alcohol extract of coal can have a weight average molecular weight that is from about 300 Da to about 2,000 Da as determined by matrix-assisted laser desorption/ionization (MALDI) mass spectrometry. The C4 to C28 alcohol extract of coal can have an apparent weight average molecular weight that is from about 300 Da to about 25,000 Da as determined by size exclusion chromatography.

In another embodiment is provided a fuel. The fuel includes a composition described herein.

In another embodiment, a solvent extracted material for use as an asphalt replacement is provided. The solvent extracted material can include a composition described herein. The solvent extracted material can further include a vegetable oil, an animal oil, an aromatic oil, a paraffin oil, or combinations thereof.

In another embodiment an asphalt or bitumen composition that resists flow at ambient temperature is provided. The asphalt or bitumen composition that resists flow at ambient temperature includes a composition described herein.

In another embodiment, an asphalt or bitumen composition that is solid at ambient temperature is provided. The asphalt or bitumen composition that is solid at ambient temperature includes a composition described herein.

In another embodiment is provided a blend that includes a C4 to C28 alcohol extract of coal. The blend can further include a polymer derived from a monomer that includes styrene, butadiene, isoprene, ethylene, propylene, vinyl chloride, methyl acrylate, vinylacetate, chloroprene, isocyanate, amide, ester, or combinations thereof. The monomer can include styrene, butadiene, or combinations thereof.

In another embodiment, a pavement formulation is provided. The pavement formulation includes a blend described herein, and an oil that includes a vegetable oil, an animal oil, an aromatic oil, a paraffin oil, a re-refined engine oil bottoms, a vacuum tower asphalt extender, or combinations thereof.

In another embodiment, a crack sealant for asphalt or concrete is provided. The crack sealant includes a blend described herein.

In another embodiment, a shingle coating is provided. The shingle coating can include a blend described herein where the C4 to C28 alcohol extract of coal is at least partially vacuum distilled.

In another embodiment, a sealant is provided. The sealant includes a blend described herein.

In another embodiment, an adhesive is provided. The adhesive includes a blend described herein.

In another embodiment is provided a composition that includes a reaction product of a C4 to C28 alcohol extract of coal with an amine, a carboxylic acid, an acid chloride, or combinations thereof.

In another embodiment, a pavement formulation is provided. The pavement formulation includes a composition that includes a reaction product of a C4 to C28 alcohol extract of coal with an amine, a carboxylic acid, an acid chloride, or combinations thereof. The pavement formulation can further include recuperated asphalt pavement, reclaimed asphalt pavement, asphalt products, reclaimed asphalt products, fresh asphalt, bituminous products, reclaimed bituminous products, fresh bitumen, or combinations thereof.

In another embodiment, an anti-stripping agent is provided. The anti-stripping agent includes a composition that includes a reaction product of a C4 to C28 alcohol extract of coal with an amine, a carboxylic acid, an acid chloride, or combinations thereof.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a process flow diagram for a pilot plant according to at least one embodiment of the present disclosure.

FIG. 2 is a counter current coal-solvent extraction reactor design according to at least one embodiment of the present disclosure.

FIG. 3 shows recovery of a single extracted product from the extraction solution according to at least one embodiment of the present disclosure.

FIG. 4 shows size exclusion chromatograms of various alcohol extracts of coal according to at least one embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to extracts of coal, compositions thereof, and uses thereof. Embodiments of the present disclosure also generally relate to processes for extracting coal. The inventors have found more sustainable, and higher conversion, processes for converting subbituminous and lignite lower-rank coals, and bio-based oxygen containing feedstocks, into desirable products or precursors thereof. Such desirable conversion products (or precursors thereof) include materials for asphalt products, hybrid biofuels, polymers, chemicals, coatings, adhesives, building materials, carbon fiber, or graphene products, among other materials. Embodiments described herein can enable improved coal extraction processes to achieve new high-value, non-hazardous and low-carbon intensity asphalt products is needed. Furthermore, utilizing domestic feedstocks, such as coal and vegetable oil derived solvents, can help US contractors be compliant with “Buy American” policies without needed to apply for waivers which often happens with many petroleum asphalts.

As described above, traditional technologies for direct coal liquefaction or solvent extraction utilize tetralin or aromatic oils to react with the coal macrostructure to break it down into smaller molecules. Such solvents are produced from petroleum, are carcinogenic, and in the case of tetralin, is expensive. Other technologies for coal liquefaction and solvent extraction are inefficient and costly, as they utilize catalysts and hydrogen at high temperatures and/or high pressures to improve the conversion. In contrast, embodiments described herein are free of catalysts. For example, a composition that includes a fatty alcohol extract of coal can be derived from coal without the use of a catalyst.

Unlike conventional technologies, embodiments described herein enable thermochemical treatment of coal with alcohols, such as fatty alcohols, to convert coal into an alcohol soluble liquid with high extraction yields. In some examples, the extraction yields can be 85% by mass (or more) of the dried coal-based feedstock. Depending on, for example, the extraction conditions, the conversion can remove from about 50% to about 98% of the coal organic phase. During operation of processes described herein, the alcohol can react with coal oxygen functional groups, and possibly other reactive carbon-hydrogen and carbon-carbon bonds, to produce hydrophobic coal extracts that are soluble in common organic solvents such as dichloromethane or toluene, and exhibit partial solubility in other organic solvents such as cyclohexane and especially heptane.

The inventors also found that adjustments in, for example, retention time and/or changes in alcohol type or alcohol length can further convert the coal extract molecules into more soluble molecules that are fully soluble in aliphatic solvents like heptane. In addition, the selection of alcohol type (for example, fully saturated versus partially unsaturated, or monohydric alcohol versus polyhydric alcohol) and/or the alcohol length (for example, C12 versus C18) for extracting coal can be utilized to tune the conversion processes. As a non-limiting example, conversion products having improved fluidity can be produced using alcohols having unsaturation (such as oleyl alcohol).

Fatty alcohols are a renewable carbon solvent that can be derived from fatty acids or triglyceride oils from biological sources (for example, algae, fungi, animal, plant-based, and lichen oil sources). Unlike tetralin and aromatic oils conventionally utilized for coal extraction, fatty alcohols are non-toxic, and for longer chain solvents they are not classified as flammable. Resultant fatty alcohol coal extracts can be further reacted to tune, for example, chemical and physical properties. As an example, different asphalt grades are utilized for different climates and traffic conditions, and embodiments described herein can enable tuning of the alcohol coal extracts so as to provide for various asphalt grades. As another example, alcohol coal extracts described herein can be utilized to produce soft oils for recycling agents. For example, alcohol coal extracts can be further reacted with additional alcohols, ethers, aldehydes, ketones, carboxylic acids, amines, among other reactive functional groups to produce recycling agents.

In the case of polyfunctional (or polyhydric) alcohols, such as ethylene glycol and glycerin, functionalized coal extracts can be produced with pendant hydroxyl groups due to reaction of one alcohol group at the coal with the other alcohol group unreacted. This unreacted hydroxyl group provides a functional group for follow-on chemistry for production of, for example, surfactants, polymers, or thermoset resins. The coal alcohol extracts can be further reacted with other fatty alcohols, fatty amines, or fatty acids to produce materials suitable for coatings, emulsions, sealants, asphalt, asphalt products, and recycling agents.

As an additional application, the hybrid bio-coal extracts are soluble in biodiesel (fatty acid methyl esters, FAME) and in some cases renewable diesel. These blends can be used as a way to reduce the cost of biodiesel and renewable diesel to make more cost competitive, low carbon emission fuels relative to other renewable and petroleum fuels. The blends can be very low sulfur fuels such as marine fuel oils. Various other non-limiting applications are described herein.

As used herein, the term “coal-based feedstock” refers to a feedstock at least partially derived from coal. A coal-based feedstock includes a solid, powder, slurry, liquid, residual, extract, fluid, mixture or other material that has been generated at least in part from a coal source, such as run of mine coal source and/or conversion products. For example, coal can be crushed into a powder prior to processing, sieved and/or formed into a slurry. A coal-based feedstock can also include environmental reclamation by using waste fines from coal production that were backfilled into coal mines, buried or deposited in tailings ponds.

A coal-based feedstock can be subject to various physical, thermal, and/or chemical treatments to further facilitate processing of the feedstock, for example, by thermal treatment, mechanical treatment, and/or chemical treatment to produce an intermediate. A coal-based feedstock (or intermediate/derivative product thereof) can be subjected to pyrolysis and/or solvent extraction treatments. The feedstock can also act as a recycled stream from one or more of the downstream processes or intermediates (for example, solid material remaining after solvent extraction) for augmentation, so that additional products, such as liquid products, can be promoted and/or enhanced by reprocessing with less valuable or unwanted intermediate products.

As used herein, the term “coal” refers to predominately solid hydrocarbons that can contain some amount of fluid material. Coal is generally composed of hydrogen, carbon, sulfur, oxygen and nitrogen, and optionally some other elements such as metals. Coal, as described herein, can refer to bituminous coal, subbituminous coal, and lignite. Coal can also refer to ash or peat. In some embodiments, coal can be sourced from Powder River Basin (Wyoming, USA) or other suitable sources. The Powder River Basin coal can be very low in sulfur, such as about 0.5 wt % or less.

As used herein, the term “solvent extraction” refers to the process of contacting a feedstock (or intermediate/derivative product thereof) with a solvent to facilitate the extraction and/or transformation of components of the material via chemical reaction(s) and/or mass transfer processes via solubility in the solvent. In some embodiments, solvent extraction is carried out by flowing a liquid solvent or mixture of solvents through, across, or over, a feedstock (or intermediate/derivative product thereof). In some embodiments, solvent extraction can be carried out as a batch process by bringing a feedstock (or intermediate/derivative product thereof) in physical contact with one or more solvents.

As described herein, solvent extraction can utilize one or more solids in one or more solvent extraction steps, including in multistage solvent extractions in which the same or similar solvents are repeatedly used on a materials. Solvents, as described herein, can be pure solvents or mixtures including mixtures of solvents generated by the processes described herein. Solvents can be derived from petrochemicals or from processes that build up higher alcohols from synthesis gas. Synthesis gas can originate from coal, or from the residues after solvent extraction processes described herein. Accordingly, solvents originating from synthesis gas can further maximize utilization of coal.

Solvents, as described herein, can be mixtures of a number of solvents. Solvents can be recycled and reused. Solvent extraction may be at subcritical temperatures. Solvent extraction can be performed at reduced pressures, atmospheric pressures or increased pressures. Solvent extraction can be at carried out at supercritical pressures and temperatures.

As used herein, the term “solvent” refers to a liquid or a mixture of liquids having solubility and/or reactivity with regard to hydrocarbons or other species and molecules present in coal (or intermediate/derivative product thereof). Solvent can refer to a liquid organic solvent or hydrocarbon or a mixture of liquids, including organic solvents (such as solvents containing at least one hydroxyl group, such as alcohols), mixtures of solvents. The solvents can be defined by boiling point ranges or other properties. In embodiments utilizing two or more solvents, solvents can be distinguished by composition, additives, molecular design, boiling point ranges, or combinations thereof. In some embodiments, the solvent can include a monohydric alcohol and/or a polyhydric alcohol, such as a C4 to C28 alcohol, such as lauryl alcohol, oleyl alcohol, stearyl alcohol, 2-ethyl-1-hexanol, cardanol, ethylene glycol, glycerin, partially hydrogenated oils from oils that contain 2 or more olefins, combinations thereof, among others. Solvents may be sourced from biomass. Here, carbon capture storage and utilization can be utilized when using biomass derived solvents.

Some embodiments described herein relate to compositions comprising an alcohol extract of coal, blends of such compositions, formulations comprising compositions. The alcohol extract of coal can be, or include, a “high value coal product”. As used herein, the term “high value coal products” can describe chemicals and materials (both solid and liquid) that are more valuable than the coal or feedstock at least partially derived from coal. High value coal products include non-fuel products, such as a product having value provided by properties, compositions and/or uses more valuable than its ability to generate energy on combustion. High value coal products can refer to liquid products generated from predominately solid coal. High value coal products can refer to products that are not fuel (for example, created for the purpose of burning to generate energy).

Examples of high value coal products include polymers (for example, polyurethane, polyesters, polyamides), high value chemicals (for example, BTX, paraffins, olefins), composite materials, carbon fiber, graphene, graphitic products, porous carbons, building materials, road, paving and roofing materials, and agricultural materials such as soil amendments, among others. High value coal products can represent a fraction of the total material converted from the feedstock, for example, 50% of the total products on a dry basis, 70% of the total products on a dry basis, 80% of the total products on a dry basis, or optionally, 90% of the total products on a dry basis.

Pressure values described herein are provided as absolute pressure values, unless otherwise indicated.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

The use of headings is for purposes of convenience only and does not limit the scope of the present disclosure. Embodiments described herein can be combined with other embodiments.

### Compositions

Embodiments described herein generally relate to compositions comprising, consisting essentially of, or consisting of an alcohol extract of coal. As described below, such compositions that include the alcohol extract of coal can be utilized as-is, as a component in a blend, mixture, or formulation, or as a reactant for a chemical reaction to form a reaction product, among other uses.

Unlike conventional asphalt, recycling agents, anti-stripping agents, sealants, coatings, and adhesives, among other products which are typically formed from petroleum feedstocks, embodiments described herein are derived from coal-based feedstocks. Moreover, conventional technologies for converting petroleum to useful products may require catalysts or other upgrading processes. Here, for example, catalytic and upgraded oil streams do not typically produce good asphalts and need to be blended with normal distilled asphalts to be useful. In contrast, compositions described herein can be formed from coal without the use of a catalyst. Further, the solvents comprising alcohol utilized for coal extraction can be sourced from biomass, such as vegetable fats, vegetable oils, animal fats, animal oils, lipids, or combinations thereof, rather than petroleum sources. In addition, conventional technologies pursue fuel applications. In contrast, embodiments described herein can include compositions comprising intermediates, derivatives, and/or finished high value products for non-fuel applications. It is contemplated that compositions described herein can be used for fuel applications.

The alcohol extract of coal can be formed by processes described herein such as solvent extraction. During solvent extraction, the alcohol can serve to depolymerize, deoligomerize, and/or deconstruct the coal macromolecular structure and react with, for example, oxygen-containing functional groups in coal molecules, coal C—H groups, and/or coal C—C bonds (alkylation) thereby providing an alcohol extract with modified properties. The term “alcohol extract” refers to an extract obtained with a solvent that includes at least one alcohol.

Suitable alcohols can include monohydric alcohols (alcohols having a single hydroxyl (—OH) group), polyhydric alcohols (alcohols having more than one hydroxyl (—OH) group), or combinations thereof. Suitable alcohols include those represented by formula (I):

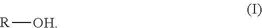

R of formula (I) is an unsubstituted hydrocarbyl, a substituted hydrocarbyl, or a functional group comprising at least one element from Group 13-17 of the periodic table of the elements. The alcohols of formula (I) can be referred to as “fatty alcohols”.

R of formula (I) can have, any suitable number of carbon atoms such as from 1 to 40 carbon atoms, such as from 2 to 32 carbon atoms, such as from 4 to 28 carbon atoms, such as from 6 to 24 carbon atoms, such as from 8 to 18 carbon atoms or from 8 to 24 carbon atoms, such as from 10 to 16 carbon atoms, such as from 12 to 14 carbon atoms, or from 8 to 40 carbon atoms, such as from 10 to 30 carbon atoms, such as from 12 to 24 carbon atoms, such as from 14 to 22 carbon atoms. Any of the foregoing numbers can be used singly to describe an open-ended range or in combination to describe a close-ended range. In some embodiments, the number of carbon atoms in R of formula (I) can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40. Each of the foregoing numbers can be preceded by the word “about,” “at least about,” “less than about,” or “more than about,” and any of the foregoing numbers can be used singly to describe an open-ended range or in combination to describe a close-ended range.

R of formula (I) can be linear or branched, saturated or unsaturated (for example, at least one C═C double bond), cyclic or acyclic, aromatic or not aromatic. Regarding saturation, R of formula (I) can be fully saturated, partially unsaturated, or fully unsaturated. Alcohols can have a double bond present at the alpha-carbon (for example, an alpha-olefin), present on an internal carbon (for example, an internal olefin), or combinations thereof. A non-limiting example of an alcohol having an internal olefin can be oleyl alcohol. Phenols or alcohols containing aromatic groups, such as cardanol, resorcinol, cresol, phenol, bisphenol, or combinations thereof, among others can be utilized.

R of formula (I) can be an unsubstituted hydrocarbyl. An “unsubstituted hydrocarbyl” refers to a group that consists of hydrogen and carbon atoms only. Non-limiting examples of unsubstituted hydrocarbyl include an alkyl group having from 1 to 40 carbon atoms such as n-butyl, iso-butyl, sec-butyl, and tert-butyl, pentyl, hexyl, heptyl, octyl, ethyl-2-hexyl, isooctyl, nonyl, n-decyl, isodecyl, undecyl, dodecyl, tridecyl, tetradecyl, pentadecyl, hexadecyl, heptadecyl, octadecyl, nonadecyl, icosyl, heneicosyl, docosyl, tricosyl, tetracosyl, pentacosyl, hexacosyl, heptacosyl, octacosyl, nonacosyl, or isomers thereof.

In some embodiments, R of formula (I) can be a substituted hydrocarbyl. A “substituted hydrocarbyl” refers to an unsubstituted hydrocarbyl in which at least one hydrogen of the unsubstituted hydrocarbyl has been substituted with at least one heteroatom or heteroatom-containing group, such as one or more elements from Group 13-17 of the periodic table of the elements, such as halogen (F, Cl, Br, or I), O, N, Se, Te, P, As, Sb, S, B, Si, Ge, Sn, Pb, and the like, such as C(O)R*, C(C)NR*₂, C(O)OR*, NR*₂, OR*, SeR*, TeR*, PR*₂, AsR*₂, SbR*₂, SR*, SOₓ (where x=2 or 3), BR*₂, SiR*₃, GeR*₃, SnR*₃, PbR*₃, and the like, where R* is, independently, hydrogen or unsubstituted hydrocarbyl, or where at least one heteroatom has been inserted within the unsubstituted hydrocarbyl.

As used herein, reference to an R group, alkyl, substituted alkyl, hydrocarbyl, substituted hydrocarbyl, aromatic, or compound name without specifying a particular isomer (such as butyl) expressly discloses all isomers (such as n-butyl, iso-butyl, sec-butyl, and tert-butyl). For example, reference to an R group having 3 or more carbon atoms expressly discloses all isomers thereof. When a compound is described herein such that a particular isomer, enantiomer or diastereomer of the compound is not specified, for example, in a formula or in a chemical name, that description is intended to include each isomer and enantiomer of the compound described individual or in any combination.

Polyhydric alcohols (compounds having more than one-OH) group can be utilized. The polyhydric alcohols can include R groups that are the same as or similar to those described above. Non-limiting examples of polyhydric alcohols can include diols and/or triols such as ethylene glycol, propylene glycol, glycerol (also called glycerin), among others.

In some embodiments, the R group is an alkoxy group (OR*) where R* is, independently, hydrogen or unsubstituted hydrocarbyl, or where at least one heteroatom has been inserted within the unsubstituted hydrocarbyl. Solvents having such R groups can include polyethers, such as fatty alcohol alkoxylates, polyethylene glycols, polysorbates, or combinations thereof. Such solvents can be utilized alone or with other solvents described herein.

In some embodiments, the alcohol comprises, consists essentially of, or consists of lauryl alcohol (1-dodecanol), undecyl alcohol, myristyl alcohol (1-tetradecanol), cetearyl alcohol (C16-C18 alcohol), cetyl alcohol (1-hexadecanol), stearyl alcohol (1-octadecanol), arachidyl alcohol (1-eicosanol), behenyl alcohol (1-docosanol), lignoceryl alcohol (1-tetracosanol), ceryl alcohol (1-hexacosanol), montanyl alcohol (1-octacosanol), linalool (a C10 alcohol), oleyl alcohol (a C18 alcohol), myricylic alcohol (1-triacontanol), linoleic alcohol (a C18 alcohol), isocetyl alcohol, isostearyl alcohol (a C18 alcohol), 2-octyl-1-dodecanol, 2-butyloctanol, 2-hexyl-1-decanol, 2-decyl-1-tetradecanol, 2-tetradecyl-1-cetanol, partially hydrogenated oils from oils that contain 2 or more olefins, partially hydrogenated oils poly-unsaturated fatty alcohols, or combinations thereof.

Combinations of alcohols having different R groups are contemplated.

Compositions that include an alcohol extract of coal can be partially vacuum distilled or fully vacuum distilled to provide a partially vacuum distilled alcohol extract of coal or a fully vacuum distilled alcohol extract of coal, respectively. A partially vacuum distilled alcohol extract of coal can be made by subjecting the alcohol extract of coal to vacuum distillation at an absolute pressure of about 5 Pa to about 6 Pa, such as about 5.3 Pa, while heating at a temperature of about 225° C. to about 275° C., such as about 250° C. A fully vacuum distilled alcohol extract of coal can be made by subjecting the alcohol extract of coal to vacuum distillation at an absolute pressure of about 5 Pa to about 6 Pa, such as about 5.3 Pa, while heating at a temperature of about 275° C. or more, such as from about 275° C. to about 325° C., such as about 300° C.

In some embodiments, compositions that include an alcohol extract of coal can further include decomposed products such as, for example, polymerized solvent such as a dimerized solvent. For example, the alcohol solvent can polymerize (for example, dimerize) during coal extraction and/or distillation to provide a polymer comprising an ether. The polymerized solvent can include a polymer derived from an alcohol monomer, such as a C4 to C28 alcohol monomer.

After distillation, the ether as well as other decomposed products may be present in the composition. Such vacuum distilled compositions can be characterized as being very stiff, for example, having a softening point of 300° C. using a Mettler Toledo Dropping/Softening Point Apparatus (DP70).

Compositions that include an alcohol extract of coal can be adjusted by, for example, residence time, during solvent extraction of the coal and/or distillation of the alcohol extract of coal. For example, the amount of polymerized solvent formation (e.g., dimer formation) can be increased with longer residence time during extraction and/or distillation. Higher amounts of solvent polymer (e.g., dimer) can affect the viscosity of the compositions that include an alcohol extract of coal.

Illustrative, but non-limiting, examples of apparatus and processes for extracting coal and forming compositions of the present disclosure are described below.

### Uses of Compositions

Embodiments of the present disclosure also generally relate to uses of compositions described herein (for example, composition that comprise, consist essentially of, or consist of an alcohol extract of coal). The compositions can be used as-is or further processed. Illustrative, but non-limiting, uses include: use as an asphalt binder; use as a partial replacement of asphalt; use as a recycling agent (also referred to as a rejuvenator or a softener); use as an anti-stripping agent; use as a crack sealant; use as a sealant for construction/roofing/automotive industry; use as a shingle/roofing coating; use as an adhesive for roofing industry; and use as a fuel. Other uses and applications are contemplated.

### Asphalt Binder

Compositions that include an alcohol extract of coal as described herein can be utilized as at least a portion of an asphalt binder. Such compositions can include a partially vacuum distilled alcohol extract of coal, a fully vacuum distilled alcohol extract of coal, or combinations thereof, as described above.

In some embodiments, an asphalt binder comprises, consists essentially of, or consists of a composition that includes an alcohol extract of coal (such as a C4 to C28 alcohol extract of coal) and optionally one or more additives. The one or more additives can include a polymer, an oil, a fluxing agent, a surfactant or combinations thereof, among others. Illustrative, but non-limiting, examples of polymers can include natural rubber, a styrene-butadiene-rubber copolymer, a styrene-butadiene-styrene (SBS) copolymer, styrene-isoprene-styrene (SIS) copolymer, polyethylene, polypropylene, nylon, polyvinyl chloride, ethylene methacrylate copolymer, ethylene propylene rubber, an ethylene vinylacetate copolymer, polybutadiene, polyisoprene, butyl rubber, styrene-butadiene rubber, polychloroprene rubber, waste tire rubber, reactive isocyanates, poly-methylene diphenyl diisocyanate (poly-MDI), polyester, polyamide, or combinations thereof, among others. In at least one example, the polymer comprises styrene-butadiene-styrene (SBS) tri-block copolymer.

The polymer can be derived from any suitable monomer such as styrene, butadiene, isoprene, ethylene, propylene, vinyl chloride, methyl acrylate, vinylacetate, chloroprene, isocyanate, amide, ester, or combinations thereof, among others. In some embodiments, the polymer can have a weight average molecular weight of about 10,000 g/mol to 600,000 g/mol, such as from about 50,000 g/mol to about 200,000 g/mol. The polymers may be physical blends or also chemically cross-linked using sulfur or other cross-linking agents.

Illustrative, but non-limiting, examples of oils can include vegetable oils, animal oils, aromatic oils, paraffin oils, or combinations thereof. Here, the vacuum distilled compositions can be characterized as being very stiff and the oils can serve to soften the composition that includes the alcohol extract of coal. Soybean oil, including high oleic alcohol soybean oil, is an example of a vegetable oil that can be used. High oleic alcohol soybean oil can be utilized for oxidative stability.

Any suitable aromatic oil can be utilized such as Hydrolene products available from Holly Frontier Specialty Products (for example, C50T, N 90T, H100T, C180 TN, H225T, H600T, and LPH, among others) and those available from HF Sinclair (such as Sundex 53). Any suitable paraffinic oil can be used such as those available from Holly Frontier Specialty Products (for example, SP 125, SP 250, RF10, RF18 and RF20, among others). These oils can help improve compatibility and performance when utilizing polymer additives with the alcohol extract of coal.

An amount of optional polymer additive in the asphalt binder, based on the total wt % of the asphalt binder, can be about 10 wt % or less, such as about 8 wt % or less, such as from about 0.3 wt % to about 8 wt %, such as from about 1.5 wt % to about 6 wt %, though other amounts are contemplated. Any of the foregoing numbers can be used singly to describe an open-ended range or in combination to describe a close-ended range. A total weight percent (wt %) of the asphalt binder is based on a total wt % of the composition that includes the alcohol extract of coal and the one or more optional additives. The total wt % does not exceed 100 wt %.

An amount of the composition that includes the alcohol extract of coal used in the asphalt binder, based on the total wt % of the asphalt binder, can be about 90 wt % or more, such as about 92 wt % or more, such as from about 92 wt % to about 99.5 wt %, such as from about 94 wt % to about 98 wt %, though other amounts are contemplated. Any of the foregoing numbers can be used singly to describe an open-ended range or in combination to describe a close-ended range.

If used, an amount of oil (such as vegetable oil, animal oil, aromatic oil, paraffin oils, or combinations thereof) in the asphalt binder, based on the total wt % of the asphalt binder, can be about 5 wt % or more, about 40 wt % or less, or combinations thereof, such as from about 5 wt % to about 40 wt %, such as from about 10 wt % to about 35 wt %, such as form about 15 wt % to about 30 wt %, though other amounts are contemplated. Any of the foregoing numbers can be used singly to describe an open-ended range or in combination to describe a close-ended range.

In some embodiments, the one or more additives of the asphalt binder can optionally include a re-refined engine oil bottoms (REOB), a vacuum tower asphalt extender (VTAE), a component thereof, or combinations thereof. REOB, VTAE, or components thereof can be utilized to soften the alcohol extract of coal, to meet low-temperature properties, or combinations thereof.

If used, an amount of REOB, VTAE, component thereof, or combination thereof in the asphalt binder, based on the total wt % of the asphalt binder, can be about 0.1 wt % or more, 20 wt % or less, or combinations thereof, such as from about 0.1 wt % to about 20 wt %, such as from about 0.5 wt % to about 15 wt %, such as form about 1 wt % to about 10 wt %, such as from about 2 wt % to about 8 wt %, though other amounts are contemplated. Any of the foregoing numbers can be used singly to describe an open-ended range or in combination to describe a close-ended range. In at least one embodiment, an amount of REOB, VTAE, component thereof, or combination thereof in the asphalt binder, based on the total wt % of the asphalt binder, can be about 10 wt % or less.

In some embodiments, the one or more additives can further include soft base asphalts.

In some embodiments, the one or more additives of the asphalt binder can optionally include a cross-linking agent. Illustrative, but non-limiting, examples of cross-linking agents can include sulfur in various forms, peroxide, a transition metal, other radical generating chemical, or combinations thereof. When a cross-linking agent is utilized in an asphalt binder, the cross-linking agent can serve to cross-link the polymer which can reduce the amount of polymer and can permit use of lower or higher molecular weight polymers for the same end point. Cross-linking can improve the compatibility and storage stability of the polymer with the asphalt binder.

Asphalt binders can be produced by physically blending the one or more optional additives, and the composition that includes the alcohol extract of coal according to any suitable method. When a cross-linking agent is utilized, addition of the cross-linking agent can result in new chemical bonds between portions of the polymer, portions of the composition described herein (for example, the composition comprising the alcohol extract of coal), and portions of the polymer with portions of the composition described herein. Any suitable method for cross-linking can be used such as by utilizing elevated temperatures, an optional accelerator, and an optional activator.

### Solid or Highly Viscous Asphalt or Bitumen Composition Material at Selected Temperatures

Generally, asphalt (or bitumen) is stored and transported under hot conditions, in bulk, in tank trucks or by boats at elevated temperatures of the order of 120° C. to 180° C. The storage and the transportation of bitumen under hot conditions can be problematic in terms of hazardous conditions, high energy costs to keep asphalt or bitumen at elevated temperatures in vessels or in tank trucks, and decreased final performance of the asphalt or bitumen, among other disadvantages.

Compositions that include an alcohol extract of coal as described herein can be utilized as at least a solid or viscous asphalt or bitumen material. Such compositions can include a partially vacuum distilled alcohol extract of coal, a fully vacuum distilled alcohol extract of coal, or combinations thereof, as described above.

In some embodiments, an asphalt or bitumen composition comprises, consists essentially of, or consists of a composition that includes an alcohol extract of coal (such as a C4 to C28 alcohol extract of coal) and optionally one or more additives. The composition that includes the alcohol extract of coal can resist flow at certain temperatures such as a temperature that is from about ambient temperature (20° C.) to about 50° C. The asphalt or bitumen composition can exist as a solid or highly viscous product at ambient temperature or elevated temperatures (such as about 50° C. or less).

In some embodiments, the asphalt or bitumen composition is solid at ambient temperature (about 20° C.). In some embodiments, the asphalt or bitumen composition that is solid at ambient temperature, that is highly viscous at ambient temperature, and/or that resists flow at ambient temperature can be utilized for the purpose of shipping at ambient temperature so that the composition does not need to be shipped, transported, or otherwise handled in the molten state.

Because the asphalt or bitumen composition resists flow at such temperatures, the asphalt or bitumen composition can be transported, stored, and/or handled at ambient temperature, thereby making it possible to overcome the disadvantages of conventional technologies. That is, the asphalt or bitumen composition can be more environmentally friendly as a result of, for example, reduced energy for transportation and storage.

The optional one or more additives can include polymers (such as those described above), an oil (such as those described above, such as a vegetable oil, aromatic oil, a REOB, a VTAE, or combinations thereof).

An amount of the composition that includes the alcohol extract of coal used in the asphalt or bitumen composition, based on the total wt % of the asphalt or bitumen composition, can be about 60 wt % or more, such as from about 60 wt % to about 99.5 wt %, such as from about 65 wt % to about 95 wt %, such as from about 70 wt % to about 90 wt %, such as from about 75 wt % to about 85 wt %, or about 90 wt % or more, such as about 92 wt % or more, such as from about 92 wt % to about 99.5 wt %, such as from about 94 wt % to about 98 wt %, though other amounts are contemplated. Any of the foregoing numbers can be used singly to describe an open-ended range or in combination to describe a close-ended range.

A total weight percent (wt %) of the asphalt or bitumen composition is based on a total wt % of the composition that includes the alcohol extract of coal and the one or more optional additives. The total wt % does not exceed 100 wt %.

If used, an amount of oil (such as vegetable oil, animal oil, aromatic oil, paraffin oils, or combinations thereof) in the asphalt or bitumen composition, based on the total wt % of the asphalt or bitumen composition, can be about 5 wt % or more, about 40 wt % or less, or combinations thereof, such as from about 5 wt % to about 40 wt %, such as from about 10 wt % to about 35 wt %, such as form about 15 wt % to about 30 wt %, though other amounts are contemplated. Any of the foregoing numbers can be used singly to describe an open-ended range or in combination to describe a close-ended range.

In some embodiments, the one or more additives of the asphalt or bitumen composition can optionally include a REOB, a VTAE, a component thereof, or combinations thereof. REOB, VTAE, or components thereof can be utilized to soften the alcohol extract of coal, to meet low-temperature properties, or combinations thereof.

If used, an amount of REOB, VTAE, component thereof, or combination thereof in the asphalt or bitumen composition, based on the total wt % of the asphalt or bitumen composition, can be about 0.1 wt % or more, 20 wt % or less, or combinations thereof, such as from about 0.1 wt % to about 20 wt %, such as from about 0.5 wt % to about 15 wt %, such as form about 1 wt % to about 10 wt %, such as from about 2 wt % to about 8 wt %, though other amounts are contemplated. Any of the foregoing numbers can be used singly to describe an open-ended range or in combination to describe a close-ended range. In at least one embodiment, an amount of REOB, VTAE, component thereof, or combination thereof in the asphalt or bitumen composition, based on the total wt % of the asphalt or bitumen composition, can be about 10 wt % or less.

Asphalt or bitumen compositions can be produced by physically blending the one or more optional additives, and the composition that includes the alcohol extract of coal according to any suitable method.

### Partial Replacement of Asphalt

Compositions that include an alcohol extract of coal as described herein can be utilized as a partial replacement of asphalt. Such compositions can include a partially vacuum distilled alcohol extract of coal, a fully vacuum distilled alcohol extract of coal, or combinations thereof, as described above

The partial replacement of asphalt is also an asphalt binder (with various additive modifications, as described above) that further includes an asphalt that is not derived from coal. That is, an asphalt that is not derived from coal can be added to an asphalt binder described above in suitable proportions. Illustrative, but non-limiting, examples of asphalts not derived from coal include petroleum-based asphalt, petroleum-based pitch, oxidized asphalt, soft bases, hard grade asphalt, multi-grade asphalt, flux, viscous oils, reclaimed asphalt, or combinations thereof, among others. The reclaimed asphalt means asphalt extracted from or remaining in reclaimed asphalt pavement.

A total weight percent of the asphalt binder is based on a total wt % of the composition that includes the alcohol extract of coal, the one or more optional additives, and the asphalt not derived from coal. The total wt % of the asphalt binder does not exceed 100 wt %.

Amounts of the composition that includes the alcohol extract of coal in the asphalt binder are described above. Amounts of the optional additives that can be utilized are described above.

An amount of asphalt not derived from coal used in the asphalt binder, based on a total wt % of the asphalt binder, can be from about 1 wt % to about 99 wt %, such as from about 10 wt % to about 90 wt %, such as from about 20 wt % to about 80 wt %, such as from about 30 wt % to about 70 wt %, such as from about 40 wt % to about 60 wt %, though other amounts are contemplated. Any of the foregoing numbers can be used singly to describe an open-ended range or in combination to describe a close-ended range.

Asphalt binders that include an asphalt not derived from coal can be produced by physically blending the composition that includes the alcohol extract of coal, the asphalt not derived from coal, and the one or more optional additives according to any suitable method.

### Recycling Agent (Rejuvenator)

Compositions that include an alcohol extract of coal as described herein can be utilized as a recycling agent. Such compositions can include a partially vacuum distilled alcohol extract of coal, a fully vacuum distilled alcohol extract of coal, or combinations thereof, as described above.

In certain applications, recycling agents are also referred to as rejuvenators or softeners. The recycling agent (or rejuvenator) can be utilized to produce a pavement. In these and other embodiments, the recycling agent can serve to ease or facilitate the mixing and incorporation of components in a pavement formulation (for example, eases the mixing of a recuperated or reclaimed asphalt pavement (RAP) or reclaimed bituminous product into fresh bitumen or into an asphalt mix, during an asphalt mix production process). The pavement formulation can be a recycled pavement formulation.

In some embodiments, a recycling agent includes a composition described herein (for example, a composition comprising an alcohol extract of coal). Additionally, or alternatively, a recycling agent includes a composition comprising a reaction product of a composition described herein (for example, a composition comprising an alcohol extract of coal) with an amine of formula (II), a carboxylic acid of formula (III), an acid chloride of formula (IV), or combinations thereof:

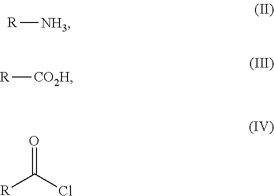

Each R of formula (II), formula (III), or formula (IV) can be, independently, those R groups described herein for formula (I). In some embodiments, the amine of formula (II) is a primary amine. In some embodiments, the carboxylic acid of formula (III) is a primary carboxylic acid. In some embodiments, the acid chloride of formula (IV) is a primary acid chloride.

Each R of formula (II), formula (III), or formula (IV) can be, independently, linear or branched, saturated or unsaturated (for example, at least one C═C double bond), cyclic or acyclic, aromatic or not aromatic. Each R of formula (II), formula (III), or formula (IV) can have, independently, any suitable number of carbon atoms such as from 4 to 28 carbon atoms. The amine of formula (II), the carboxylic acid of formula (III), and the acid chloride of formula (IV) can be referred to as “fatty amines”, “fatty acids”, and “fatty acid chlorides”, respectively.

The reaction product can be formed from reacting one or more oxygen groups (for example, hydroxyl groups) present in the alcohol extract of coal with an amine, carboxylic acid, an acid chloride, or combinations thereof. Additionally, or alternatively, the reaction product can be an alkylation reaction product formed from reacting a coal-OH group, a coal-CH group, or coal-CC group present in the alcohol extract of coal with an amine, carboxylic acid, acid chloride, or combinations thereof. With amines, an alkyl chain transfer type reaction can occur. Additionally, or alternatively, the reaction product can be an ester product formed from reacting a hydroxyl group present in the alcohol extract of coal with a carboxylic acid. Such esterification reactions can occur at temperatures of about 200° C. or more. In some cases, a condensation reaction product can be formed by reaction of the alcohol extract of coal (e.g., a hydroxyl group) with the production of water. In some embodiments, the reaction product can be an ester, an ether, an alkyl chain transfer product, or combinations thereof.

In some embodiments, the recycling agent can further include an oil such as a vegetable oil, animal oil, aromatic oil, paraffin oil, or combinations thereof, such as those vegetable oils, animal oils, aromatic oils, and paraffin oils described above. Addition of oil can make the alcohol extract of coal softer, more recyclable, more soluble in heptane, lower in viscosity, or combinations thereof. Similarly, reaction products of a composition described herein with an amine of formula (II), a carboxylic acid of formula (III), an acid chloride of formula (IV), or combinations thereof can also make the alcohol extract of coal softer, more recyclable, more soluble in heptane, lower in viscosity, or combinations thereof. The recycling agent can be viscous or an oil at room temperature.

The recycling agent, with or without an oil, can be utilized in a pavement formulation such as a recycled pavement formulation. Accordingly, a pavement formulation can include a recycling agent and one or more optional additives.

The one or more optional additives can include bitumen (or asphalt), RAP, bituminous products, reclaimed bituminous products, fresh (or virgin) bitumen, or combinations thereof. RAPs also include recycled asphalt mixes wherein the mineral aggregates are replaced in whole or in part with other common components, such as, organic and inorganic fibers (for example, glass fibers, metal fibers, carbon fibers, cellulose, cotton, aramid, or combinations thereof, among others), polymers (for example, polypropylenes, polyesters, poly(vinyl alcohol) s, polyamides, polyurethanes, polyureas, ethyl vinyl acetate (EVA) SBS polymers, or combinations thereof, among others).

Recuperated or reclaimed aggregates, commonly known as RAP, are the result of milling (or other grinding method) of previously constructed pavements, which are generally damaged and need to be replaced. These recuperated or reclaimed aggregates contain bitumen (the one used as binder during their previous fabrication). RAP can also include asphalt binder and fines. Other sources of bituminous products that may also be recycled into pavement fabrication are for example roofing products (such as shingles or waterproofing membranes, as well as waste materials coming from their production), isolation or sound damping materials, or combinations thereof, among others.

The term “reclaimed bituminous product” and “reclaimed asphalt products” refers to any suitable manufactured product that includes bitumen or asphalt as one of its components, and the manufactured product that includes bitumen or asphalt has been previously used or discarded after production. Illustrative, but non-limiting, examples of such reclaimed bituminous products and reclaimed asphalt products, can include are the reclaimed asphalt pavement (also known as RAP) obtained from the milling of roads and other rolling surfaces, waterproof membranes, bituminous shingles used in roofing (reclaimed asphalt shingle, RAS), sound-proof panels, wastes coming from their production, or combinations thereof, among others. The term “fresh bitumen” and “fresh asphalt” refers to bitumen and asphalt which has not already been contacted with aggregates for the preparation of pavement or asphalt mixes.

A total weight percent of the pavement formulation is based on a total wt % of the recycling agent and the one or more optional additives. The total wt % of the pavement formulation does not exceed 100 wt %.

An amount of recycling agent in the pavement formulation, based on a total wt % of the pavement formulation, can be about 0.5 wt % or more, such as from about 3 wt % to about 10 wt %, such as from about 5 wt % to about 9 wt %, such as from about 6 wt % to about 8 wt %, though other amounts are contemplated. Any of the foregoing numbers can be used singly to describe an open-ended range or in combination to describe a close-ended range.

An amount of the one or more optional additives in the pavement formulation, based on a total wt % of the pavement formulation, can be about 99.5 wt % or less, such as from about 90 wt % to about 97 wt %, such as from about 91 wt % to about 95 wt %, such as from about 92 wt % to about 94 wt %, though other amounts are contemplated. Any of the foregoing numbers can be used singly to describe an open-ended range or in combination to describe a close-ended range.

Pavement formulations can be produced by physically blending the aforementioned materials according to any suitable method.

### Anti-Stripping Agent

Anti-stripping agents are used for bituminous (or asphalt) mixes and materials to increase the strength of adhesion between bitumen (or asphalt) and aggregates, even when submerged in water.

Compositions that include an alcohol extract of coal as described herein can be utilized as at least a portion of an anti-stripping agent. Such compositions can include a partially vacuum distilled alcohol extract of coal, a fully vacuum distilled alcohol extract of coal, or combinations thereof, as described above. In some embodiments, an anti-stripping agent includes a composition comprising a reaction product of a composition described herein (for example, a composition comprising an alcohol extract of coal) with an amine of formula (II). The reaction product can be formed from reacting one or more oxygen groups (for example, hydroxyl groups) present in the alcohol extract of coal with the amine of formula (II). Additionally, or alternatively, the reaction product can be an alkylation reaction product formed from reacting a coal —OH group, a coal —CH group, or coal —CC group present in the alcohol extract of coal with an amine. With amines, an alkyl chain transfer type reaction can occur. In some cases, a condensation reaction product can be formed by reaction of the alcohol extract of coal (e.g., a hydroxyl group) with the production of water. In some embodiments, the reaction product can be an alkyl chain transfer product.

The composition comprising the reaction product can be used as an anti-stripping agent. The anti-stripping agent can be applied to bitumen (or asphalt), recuperated or reclaimed asphalt pavement (RAP), asphalt products, reclaimed asphalt products, bituminous products, reclaimed bituminous products, fresh bitumen, fresh asphalt, or combinations thereof. The anti-stripping agent described herein can be utilized to increase the stripping resistance of the bitumen-coated (or asphalt-coated) aggregates.

### Crack Sealant

Cracks in roadways made of, for example, cement concrete pavement or asphaltic concrete pavement, can develop over time. As a treatment, cracks can be filled with a crack sealant.

Compositions that include an alcohol extract of coal as described herein can be utilized as at least a portion of a crack sealant. Such compositions can include a partially vacuum distilled alcohol extract of coal, a fully vacuum distilled alcohol extract of coal, or combinations thereof, as described above.

In some embodiments, a crack sealant comprises, consists essentially of, or consists of a composition that includes an alcohol extract of coal (such as a C4 to C28 alcohol extract of coal) and optionally one or more additives. The one or more additives can include a polymer. Illustrative, but non-limiting, examples of polymers can include natural rubber, a styrene-butadiene-rubber copolymer, a styrene-butadiene-styrene (SBS) copolymer, styrene-isoprene-styrene (SIS) copolymer, polyethylene, polypropylene, nylon, polyvinyl chloride, ethylene methacrylate copolymer, ethylene propylene rubber, an ethylene vinylacetate copolymer, polybutadiene, polyisoprene, butyl rubber, styrene-butadiene rubber, polychloroprene rubber, waste tire rubber, reactive isocyanates, poly-methylene diphenyl diisocyanate (poly-MDI), polyester, polyamide, or combinations thereof, among others. In at least one example, the polymer comprises styrene-butadiene-styrene (SBS) tri-block copolymer.

The polymer can be derived from any suitable monomer such as styrene, butadiene, isoprene, ethylene, propylene, vinyl chloride, methyl acrylate, vinylacetate, chloroprene, isocyanate, amide, ester, or combinations thereof, among others. In some embodiments, the polymer can have a weight average molecular weight of about 10,000 g/mol to 600,000 g/mol, such as from about 50,000 g/mol to about 200,000 g/mol. The polymers may be physical blends or also chemically cross-linked using sulfur or other cross-linking agents.

An amount of optional polymer additive in the crack sealant, based on the total wt % of the crack sealant, can be about 40 wt % or less, such as from about 0.5 wt % to about 40 wt %, such as from about 1 wt % to about 35 wt %, such as from about 5 wt % to about 30 wt %, such as from about 10 wt % to about 25 wt %, such as from about 15 wt % to about 20 wt %, though other amounts are contemplated. Any of the foregoing numbers can be used singly to describe an open-ended range or in combination to describe a close-ended range. A total wt % of the crack sealant is based on a total wt % of the composition comprising (or consisting of) the alcohol extract of coal and the one or more optional additives. The total wt % of the crack sealant does not exceed 100 wt %.

An amount of the composition that includes the alcohol extract of coal used in the crack sealant, based on the total wt % of the crack sealant, can be about 60 wt % or more, such as from about 60 wt % to about 99.5 wt %, such as from about 65 wt % to about 99 wt %, such as from about 70 wt % to about 95 wt %, such as from about 75 wt % to about 90 wt %, such as from about 80 wt % to about 85 wt %, though other amounts are contemplated. Any of the foregoing numbers can be used singly to describe an open-ended range or in combination to describe a close-ended range.

In some embodiments, the one or more additives of the crack sealant can optionally include a cross-linking agent. Illustrative, but non-limiting, examples of cross-linking agents can include sulfur in various forms, peroxide, a transition metal, other radical generating chemical or combinations thereof. When a cross-linking agent is utilized in a crack sealant, the cross-linking agent can serve to cross-link the polymer which can reduce the amount of polymer and can permit use of lower or higher molecular weight polymers for the same end point. Cross-linking can improve the compatibility and storage stability of the polymer with the crack sealant.

Crack sealants can be produced by physically blending the one or more optional additives, and the composition that includes the alcohol extract of coal according to any suitable method. When a cross-linking agent is utilized, addition of the cross-linking agent can result in new chemical bonds between portions of the polymer, portions of the composition described herein (for example, the composition comprising the alcohol extract of coal), and portions of the polymer with portions of the composition described herein. Any suitable method for cross-linking can be used such as by utilizing elevated temperatures, an optional accelerator, and an optional activator.

The crack sealant can be applied to roadways, sidewalks, parking lots and structures, bridge decks, concrete pavements, and other matter that includes cement concrete pavement and/or asphaltic concrete pavement.

### Sealant for Construction or Roofing Industry

Compositions that include an alcohol extract of coal as described herein can be utilized as at least a portion of a sealant used in, for example, in the construction or roofing industry. Such compositions can include a partially vacuum distilled alcohol extract of coal, a fully vacuum distilled alcohol extract of coal, or combinations thereof, as described above.

In some embodiments, a sealant comprises, consists essentially of, or consists of a composition that includes an alcohol extract of coal and optionally one or more additives. The one or more additives can include a polymer. Illustrative, but non-limiting, examples of polymers can include natural rubber, a styrene-butadiene-rubber copolymer, a styrene-butadiene-styrene (SBS) copolymer, styrene-isoprene-styrene (SIS) copolymer, polyethylene, polypropylene, nylon, polyvinyl chloride, ethylene methacrylate copolymer, ethylene propylene rubber, an ethylene vinylacetate copolymer, polybutadiene, polyisoprene, butyl rubber, styrene-butadiene rubber, polychloroprene rubber, waste tire rubber, reactive isocyanates, poly-methylene diphenyl diisocyanate (poly-MDI), polyester, polyamide, or combinations thereof, among others. In at least one example, the polymer comprises styrene-butadiene-styrene (SBS) tri-block copolymer.

The polymer can be derived from any suitable monomer such as styrene, butadiene, isoprene, ethylene, propylene, vinyl chloride, methyl acrylate, vinylacetate, chloroprene, isocyanate, amide, ester, or combinations thereof, among others. In some embodiments, the polymer can have a weight average molecular weight of about 10,000 g/mol to 600,000 g/mol, such as from about 50,000 g/mol to about 200,000 g/mol. The polymers may be physical blends or also chemically cross-linked using sulfur or other cross-linking agents.

The choice of polymer(s) can impact properties of the sealant. For example, use of a styrene-butadiene-rubber copolymer, a styrene-butadiene-styrene (SBS) copolymer, or combinations thereof, among others, can impart softness to the sealant. As another example, polypropylene, polyethylene, or combinations thereof, among others, can impart stiffness to the sealant.

An amount of optional polymer additive in the sealant, based on the total wt % of the sealant, can be about 40 wt % or less, such as from about 0.5 wt % to about 40 wt %, such as from about 1 wt % to about 35 wt %, such as from about 5 wt % to about 30 wt %, such as from about 10 wt % to about 25 wt %, such as from about 15 wt % to about 20 wt %, though other amounts are contemplated. Any of the foregoing numbers can be used singly to describe an open-ended range or in combination to describe a close-ended range. A total wt % of the sealant is based on a total wt % of the composition that includes the alcohol extract of coal and the one or more optional additives. The total wt % of the sealant does not exceed 100 wt %.

An amount of the composition that includes the alcohol extract of coal used in the sealant, based on the total wt % of the sealant, can be about 60 wt % or more, such as from about 60 wt % to about 99.5 wt %, such as from about 65 wt % to about 99 wt %, such as from about 70 wt % to about 95 wt %, such as from about 75 wt % to about 90 wt %, such as from about 80 wt % to about 85 wt %, though other amounts are contemplated. Any of the foregoing numbers can be used singly to describe an open-ended range or in combination to describe a close-ended range.

In at least one embodiment, a sealant includes from about 80 wt % to about 90 wt % (such as about 85 wt %) of a composition that includes the alcohol extract of coal based on the total wt % of the sealant; and from about 10 wt % to about 20 wt % (such as about 15 wt %) of a polymer based on the total wt % of the sealant.

Sealants can be produced by physically blending the composition that includes the alcohol extract of coal and the one or more optional additives according to any suitable method. The sealant can be applied to, for example, roofs, commercial structures, residential structures, among other structures.

### Coatings and Adhesives

Compositions that include an alcohol extract of coal as described herein can be utilized as at least a portion of a coating or an adhesive used in, for example, in the roofing industry. Such compositions can include a partially vacuum distilled alcohol extract of coal, a fully vacuum distilled alcohol extract of coal, or combinations thereof, as described above.

In some embodiments, a coating or an adhesive can include a composition comprising a heavily or fully vacuum distilled alcohol extract of coal. Such heavily or fully distilled alcohol extracts of coal can be stiff and useful to replace, for example, air blown coatings.

In some embodiments, a coating or an adhesive comprises, consists essentially of, or consists of a composition that includes an at least partially distilled alcohol extract of coal and optionally one or more additives. The one or more additives can include a polymer. Illustrative, but non-limiting, examples of polymers can include natural rubber, a styrene-butadiene-rubber copolymer, a styrene-butadiene-styrene (SBS) copolymer, styrene-isoprene-styrene (SIS) copolymer, polyethylene, polypropylene, nylon, polyvinyl chloride, ethylene methacrylate copolymer, ethylene propylene rubber, an ethylene vinylacetate copolymer, polybutadiene, polyisoprene, butyl rubber, styrene-butadiene rubber, polychloroprene rubber, waste tire rubber, reactive isocyanates, poly-methylene diphenyl diisocyanate (poly-MDI), polyester, polyamide, or combinations thereof, among others. In at least one example, the polymer comprises styrene-butadiene-styrene (SBS) tri-block copolymer.

The polymer can be derived from any suitable monomer such as styrene, butadiene, isoprene, ethylene, propylene, vinyl chloride, methyl acrylate, vinylacetate, chloroprene, isocyanate, isocyanate, amide, ester, or combinations thereof, among others. In some embodiments, the polymer can have a weight average molecular weight of about 10,000 g/mol to 600,000 g/mol, such as from about 50,000 g/mol to about 200,000 g/mol. The polymers may be physical blends or also chemically cross-linked using sulfur or other cross-linking agents.

An amount of optional polymer additive in the coating (or adhesive), based on the total wt % of the coating (or adhesive), can be about 40 wt % or less, such as from about 0.5 wt % to about 40 wt %, such as from about 1 wt % to about 35 wt %, such as from about 5 wt % to about 30 wt %, such as from about 10 wt % to about 25 wt %, such as from about 15 wt % to about 20 wt %, though other amounts are contemplated. Any of the foregoing numbers can be used singly to describe an open-ended range or in combination to describe a close-ended range. A total wt % of the coating (or adhesive) is based on a total wt % of the composition that includes the alcohol extract of coal and the one or more optional additives. The total wt % of the coating (or adhesive) does not exceed 100 wt %.

An amount of the composition that includes the alcohol extract of coal used in the coating (or adhesive), based on the total wt % of the coating (or adhesive), can be about 60 wt % or more, such as from about 60 wt % to about 99.5 wt %, such as from about 65 wt % to about 99 wt %, such as from about 70 wt % to about 95 wt %, such as from about 75 wt % to about 90 wt %, such as from about 80 wt % to about 85 wt %, though other amounts are contemplated. Any of the foregoing numbers can be used singly to describe an open-ended range or in combination to describe a close-ended range.

Coatings and adhesives can be produced by physically blending the composition that includes the alcohol extract of coal and the one or more optional additives according to any suitable method. The coating (or adhesive) can be applied to, for example, a shingle utilized for roofs such as sloped roofs.

### Fuel

Compositions that include an alcohol extract of coal as described herein can be utilized as at least a portion of a fuel. Such compositions can include a partially vacuum distilled alcohol extract of coal, a fully vacuum distilled alcohol extract of coal, or combinations thereof, as described above.

In some embodiments, a fuel comprises consists essentially of, or consists of a composition that includes an alcohol extract of coal and one or more of a biodiesel (FAME), renewable diesel, bio-oils, pyrolysis oils from biomass, oils from depolymerization of waste, pyrolysis oils from wastes, bunker fuels, bunker crudes, heavy fuel oil, marine fuel oil, upgraded petroleum fuels, catalytically upgrade petroleum fuels, heavy oils, petroleum residues, or combinations thereof, among others.

The fuel blend can include any suitable ratio of alcohol extract of coal to the one or more of biodiesel, renewable diesel, bio-oils, pyrolysis oils from biomass, oils from depolymerization of waste, pyrolysis oils from wastes, bunker fuels, bunker crudes, heavy fuel oil, marine fuel oil, upgraded petroleum fuels, catalytically upgrade petroleum fuels, heavy oils, petroleum residues, or combinations thereof, among others. Such ratios (volume ratios) include from about 1:10 to about 10:1, such as from about 1:5 to about 5:1, such as from about 1:3 to about 3:1, such as from about 1:2 to about 2:1, such as about 1:1, though other values are contemplated. Any of the foregoing numbers can be used singly to describe an open-ended range or in combination to describe a close-ended range.

Use of the alcohol extract of coal can reduce the cost of fuels such as biodiesel and renewable diesel to make more cost competitive, low carbon emission fuels relative to conventional renewable and petroleum fuels. The fuel blends can be very low sulfur fuels such as those utilized as marine fuel oils.

Fuel blends can be produced by physically blending the composition that includes the alcohol extract of coal and the one or more optional additives according to any suitable method.

### Apparatus and Processes

Embodiments described herein also relate to processes for extracting coal. The processes rely, at least in part, on utilizing a solvent that includes an alcohol. Compositions described herein (for example, compositions comprising an alcohol extract of coal) can be formed using suitable processes and apparatus as described in, for example, US Patent Application Publication Nos. 2022/0177312, 2022/0154075, 2020/0332197, and, each of which are incorporated herein by reference in their entireties to the extent it is not inconsistent with the description herein. One suitable apparatus and process is described herein.

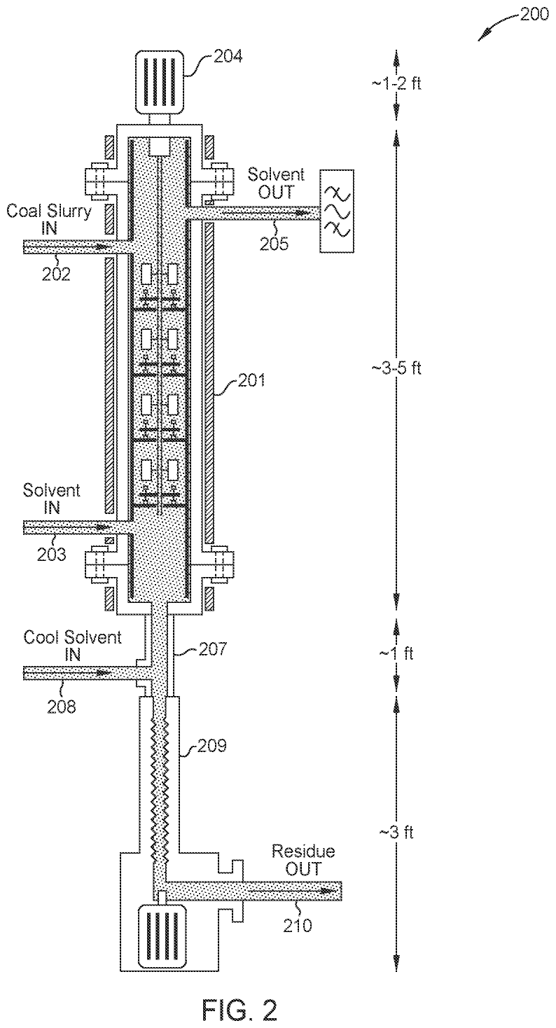

The apparatus generally includes an extraction reactor and a staged product precipitation scheme further described below. An extraction reactor (or extractor), such as a counter-current coal extraction reactor, is shown in FIG. 2 and described below. The extractor provides an example of a means for reducing the volume of solvent (for example, solvent/coal ratio) needed to effectively extract effective/target yields of solid and liquid intermediate products from coal. This feature can allow for greater coal throughput. The extractor is one example of a large number of systems and techniques for solvent extraction including batch and flow processes for a wide range of feedstock compositions and scales. The systems and methods can use a solvent/coal weight ratio selected from 1:1 to 50:1, such as from about 5:1 to about 50:1. In an embodiment, for example, a batch extraction system can use a 20:1 (±10%) solvent/coal weight ratio and optionally a 10:1 (±10%) solvent/coal weight ratio.

Processes for forming an alcohol extract of coal can include solvent extraction, fractionation, pyrolysis, or combinations thereof.

The process conditions can be adjusted to control yields, composition, and product properties, for example, to provide tunable control of the identity, properties, and branching to products. In some embodiments, a coal-based feedstock is split into at least 2 fractions including: (1) Residue: a component that doesn't dissolve in the solvent(s) under the solvent extraction conditions; (2) Alcohol soluble (AI): a component that dissolves in the solvent(s) under the solvent extraction conditions and is generally soluble in the liquid solvent(s).

The coal-based feedstock and/or intermediate can be extracted with a solvent comprising an alcohol, and the resultant extract can be optionally fractionated. The coal-based feed can be prepared via or more pre-extraction treatments and/or processes prior to solvent extraction and/or fractionation. Pre-extraction treatments can include mechanical treatment (for example, pulverizing, grinding, sieving, mixing, and/or formation of a slurry, among others), thermal treatment (for example, drying, heating, and/or pyrolysis, among others) and/or chemical treatment (for example, solvent extraction, and/or chemical reaction, among others).

Prior to extraction, the coal can be ground and sieved, for example, to a particle size range of about 10 mesh to about 60 mesh (about 250 to 2,000 microns in size). The coal or a derivative thereof can be dried in an oven, for example, by heating to a temperature greater than about 60° C. for a time period greater than about 10 hours, such as heating to a temperature of about 60° C. to about 120° C. for a time period of about 10 hours to about 70 hours. In some examples, the coal can be dried at about 90° C. for about 48 hours to remove moisture. In some examples, the drying can be performed under a reduced pressure using a vacuum.

After the optional pre-extraction treatment, the coal-based feedstock is contacted with a solvent so as to achieve solvent extraction and/or chemical modification. For example, after drying, the coal-based feedstock is loaded into the reactor(s) and into the oven. The system is then pressurized with N₂ or argon to a pressure of about 120 psi (0.83 MPa) to about 1,000 psi (6.89 MPa), such as from about 250 psi (1.7 MPa) to about 500 psi (3.45 MPa). The reactors are then heated to about 250° C. to about 400° C., such as from about 275° C. to about 370° C., at a rate of about 5° C./minute. Solvent is flowed through the system until the reactors are full of solvent. The solvent flow continues at a calculated flow rate throughout the duration of the extraction.

Any suitable flow rate can be utilized. For example, the solvent flow rate can be from about 1 mL/h to about 100 mL/h, such as from about 20 mL/h to about 80 mL/h, such as from about 30 mL/h to about 50 mL/h, or from about 5 mL/h to about 40 mL/h, such as from about 10 mL/h to about 30 mL/h, such as from about 15 mL/h to about 25 mL/h. Any of the foregoing numbers can be used singly to describe an open-ended range or in combination to describe a close-ended range. The solvent flow rate can be calculated at about 0.1 ml per min per gram of dry coal in the reactor(s). The duration of the extraction can be any suitable period such as about 2 hours starting when the reactor temperature, as measured by a thermocouple in the solvent line in the oven, reaches about 350° C. This results in a solvent use to coal ratio of about 20:1 by volume.

If desired, the product(s) of solvent extraction or a derivative thereof can be subjected to fractionation. The remainder insoluble phase can be physically separated from the soluble phase. The soluble phase can be fractionated to generate two or more fractionation products, for example via partial precipitation fractional crystallization, fractional freezing, which may be carried out by a range of techniques well known in the art including but not limited to via flash precipitation. Collection of precipitated fractions may be carried out by a range of techniques well known in the art include but not limited to filtration, washing, purification and/or drying.

In some embodiments, staged cooling can be used to fractionate products. In some embodiments, for example for commercial production, the mixture pressure may be sequentially lowered thereby vaporizing a portion of the solvent, causing precipitation to occur primarily due to concentration of the dissolved species and secondarily by the temperature reduction that occurs when the solvent vaporizes.

If desired, at least a portion of the solvent comprising alcohol can be distilled off by, for example, using a rotary evaporator or other suitable apparatus such as distillation tower. The DR material can remain liquid at distillation temperatures but may solidify at room temperature. The DR material can be further dried in a vacuum oven to remove remaining solvent.

In some embodiments, the solvent can include a single alcohol or a mixture of alcohols. In some embodiments, and when the solvent includes two or more alcohols, the proportions of at least two of the alcohols in the solvent mixture can be from about 9:1 to about 1:9, such as form about 8:2 to about 2:8, such as form about 7:3 to about 3:7, such as form about 6:4 to about 4:6, such as about 1:1, though other values are contemplated. Any of the foregoing numbers can be used singly to describe an open-ended range or in combination to describe a close-ended range

In some embodiments, the solvent may further include a non-alcoholic solvent such as a hydrocarbon solvent, such as a hydrocarbon that includes from 4 to 28 carbon atoms, such as from 6 to 24 carbon atoms, such as from 8 to 18 carbon atoms, such as from 10 to 16 carbon atoms, such as from 12 to 14 carbon atoms, or from 8 to 40 carbon atoms, such as from 10 to 30 carbon atoms, such as from 12 to 24 carbon atoms, such as from 14 to 22 carbon atoms. Any of the foregoing numbers can be used singly to describe an open-ended range or in combination to describe a close-ended range. In some embodiments, the number of carbon atoms in the optional hydrocarbon solvent can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40. Each of the foregoing numbers can be preceded by the word “about,” “at least about,” “less than about,” or “more than about,” and any of the foregoing numbers can be used singly to describe an open-ended range or in combination to describe a close-ended range.

The optional hydrocarbon solvent (which can form part of the solvent for extraction) can be linear or branched, saturated or unsaturated (for example, at least one C═C double bond), cyclic or acyclic, aromatic or not aromatic. When an optional hydrocarbon solvent is utilized, the mixture of solvents can include the same or similar proportions described above with respect to a solvent that include two or more alcohols.

In operation, compositions described herein can be formed or produced utilizing any suitable reactor. An illustrative, but non-limiting, example of a reactor includes a Swagelok tube reactor. Coal, which may be milled, is positioned in the reactor. The reactor can be pressurized and heated at a temperature of about 250° C. to about 400° C., such as from about 275° C. to about 370° C. A solvent or solvent mixture is then flowed into the reactor at a selected flow rate where it contacts the coal. The solvent containing the extract of coal is collected.

Compositions described herein can be formed or produced utilizing an example continuous plant that uses solvent extraction of coal. As will be generally understood by one having skill in the art, the processes, systems and conditions of this example may be scaled up via known techniques and systems to provide for commercial implementation. Such scale up approaches are known in the art.

As described above, coal solvent extraction can be a useful step in processing converting coal-based feedstocks into compositions comprising high value products. Products from coal solvent extraction can result in end products and/or intermediates useful to produce salable end products.

The plant throughput can be initially set at 4 lbs/hour coal feed. This small size can address material handling issues with feedstocks and products. A typical plant run can be expected to last at least 2 hours. As will be readily understood, the scale, dimensions, components and process conditions described herein can be adapted to large scale commercial implementation via well-known systems and techniques in the art.

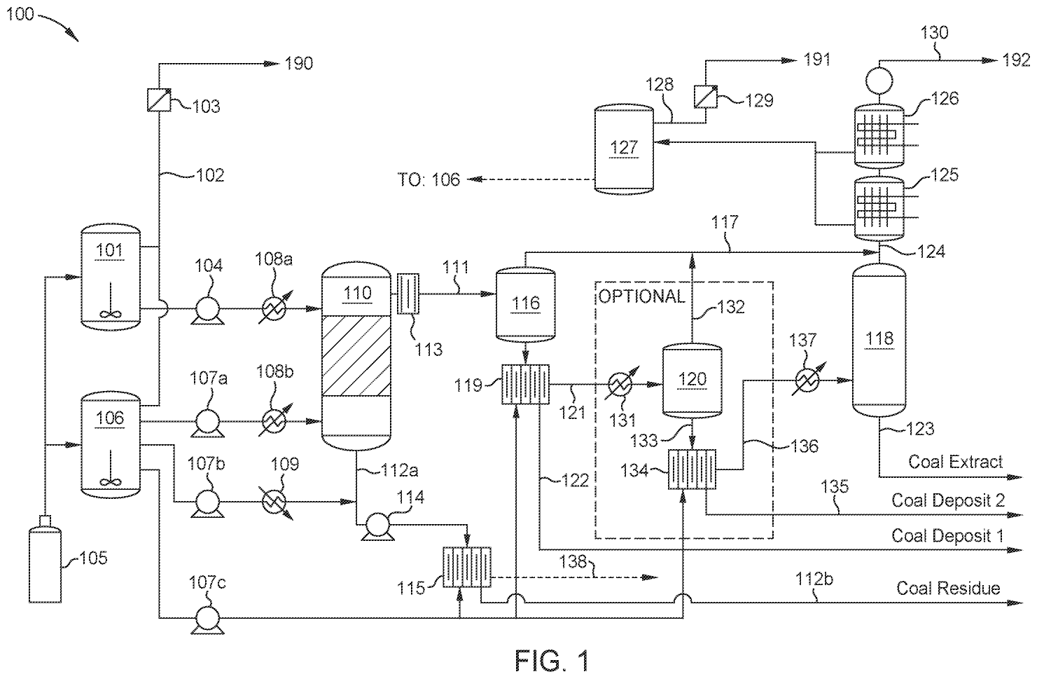

FIG. 1 shows a simplified process flow diagram for a pilot plant 100 that can be utilized to form or produce compositions described herein. Coal sufficient for a 2 hour run is batch loaded into the feed slurry tank 101, along with sufficient solvent to produce a pumpable slurry. In an embodiment, the feed slurry tank 101 is at ambient temperature and pressure (for example, 25° C. and 1 bar). Optionally, an agitator mixes the feed slurry to keep it at a relatively uniform composition. The feed slurry tank 101 may be covered, but can be opened to reload the feed slurry tank 101.

A vent line 102, which can include a safety-check valve 103, attached to the feed slurry tank 101 minimizes vapor exposure to operators and other building occupants. Vent gas 190 can exit the feed slurry tank 101 by vent line 102. In an embodiment, a feed pump 104 is coupled to the feed slurry tank 101. The feed pump 104 can be a Moyno-style progressive cavity pump, which is capable of pumping high solids slurries. The feed pump 104 can have a variable speed drive to control the feed rate. An inert gas purge cylinder is coupled to the feed slurry tank 101. The plant 100 includes a solvent tank 106. In an embodiment, the feed slurry tank 101 is at ambient temperature and pressure (for example, 25° C. and 1 bar). Solvent pumps 107a, 107b, and 107c are coupled to the solvent tank 106.

The plant 100 includes an extraction reactor 110 coupled to the feed slurry tank 101 and to the solvent tank 106. In some embodiments, the extraction reactor 110 is a coal-solvent extraction reactor. Feed slurry is fed to the extraction reactor 110 via feed pump 104 and solvent is fed to the extraction reactor 110 via solvent pump 107a. Positioned between the feed pump 104 and the extraction reactor 110 is a pre-heater 108a. Positioned between the solvent pump 107a and the extraction reactor 110 is a pre-heater 108b.

In example batch experiments, solvent flows at a rate, optionally a constant rate, through a cylinder packed with coal until the produced liquid starts to clear, indicative that no more coal components are being extracted. This results in a high solvent/coal ratio, about 20:1, and a 2 hour extraction time. Other solvent/coal ratios and extraction times are potentially useful in the present reactor, such as a solvent ratio (volume solvent to volume coal) selected from the range of 5:1 to 100:1 and extraction selected over 0.5 hours to 100 hrs. A reduction in the solvent/coal ratio may be desirable in some embodiments to reduce the cost of coal extraction and may reduce the extraction time.

To make extraction more efficient, the counter current extraction reactor 110 having a design 200 may be utilized, as shown in FIG. 2. The design 200 for this component may vary, but for illustrative purpose only, herein assumes that a 10:1 solvent/coal ratio will be used, and that the extraction time will be about one hour. The extractor operates at about 250° C. to about 400° C., which is the same temperature used for at least some of the batch experiments. The extractor temperature is maintained by a thermal control system, such as an electric clamshell heater. In some embodiments, the extractor pressure may be set to a certain pressure to keep the solvent in the liquid state. As will be generally understood by one of skill in, a variety of temperature, pressure, and flow rate conditions are compatible with the present systems and methods.

The design 200 of the counter current extraction reactor 110 can include a flanged tube reactor 201. Coal slurry can enter the flanged tube reactor 201 via inlet 202. Solvent can enter the flanged tube reactor 201 via inlet 203 and exit the flanged tube reactor 201 via outlet 205 where it can contact a filter 206 (such as a Fines filter). Mixing inside the flanged tube reactor 201 can be accomplished by use of a variable speed magnet drive motor assembly 204. Coal residue can be removed from the flanged tube reactor 201 as a slurry via line 207 and coal residue slurry pump 209. The coal residue slurry pump 209 can be a Moyno-style progressive cavity pump or a Moyno dosing pump. Chilled or cooled solvent can enter line 207 via inlet 208 where it can mix with the coal residue. Coal residue exits the design 200 via outlet 210.

Referring back to FIG. 1, coal slurry is pumped to into the extraction reactor 110, for example, via or proximate to the top of the extraction reactor 110. In an embodiment, the extraction reactor 110 is designed as a countercurrent extractor, with solids entering the extractor near the top of the vessel and falling down through the vessel. Most of the solvent (aside from the solvent used to slurry the feed coal), enters the extraction reactor near the bottom of the vessel, so liquid flows up the vessel, contacting the solids falling down the vessel.

A set of agitators such as agitator paddles on a common shaft, and static baffles between sets of agitators, improve solid/liquid contacting. The agitators may be driven by a variety of methods such as a variable speed drive, and the rotational speed will need to be adjusted in some of the early plant runs to find a workable speed. Higher rotational speeds may improve solid/liquid contacting, but in some instances may interfere with coal settling, which is needed to direct the solids down through the extractor. Coal residue is removed from the bottom of the extraction reactor as a slurry via line 112a and coal residue slurry pump 114. Additional solvent can be fed via solvent pump 107b to mix with the coal residue. The additional solvent can be cooled by a cooler 109. Coal residue can exit filter 115 via line 112b coupled to, for example, a solvent tank or a flash evaporator as indicated by the dashed arrow 138.

The coal residue can be filtered by filter 115. A wash solvent can be fed from solvent tank 106 via solvent pump 107c to filter 115 where it can be utilized to wash the coal residue. In this embodiment, the solution, comprising solvent and the dissolved coal species (e.g., solvent extract of coal), flows out of the top of the vessel via line 111 to the flash evaporator 116. The solvent and dissolved coal species can be filtered by filter 113.

An embodiment of separation apparatus is also shown in FIG. 1. At the flash evaporator 116, the solvent and the dissolved coal species (e.g., solvent extract of coal) can be heated to a selected temperature and pressurized at a certain pressure to separate components. Vapor comprising dissolved coal species can travel via line 117 to an evaporator 118. At the evaporator 118, the vapor comprising dissolved coal species can be separated into a volatile phase and a differently volatile phase. The differently volatile phase containing coal extract (e.g., alcohol extract of coal, dissolved coal species, etc.) can exit evaporator 118 via line 123.

The volatile phase exiting the evaporator 118 via line 124 can travel through a water-cooled condenser 125 and chilled condenser 126. The resulting condensed component can be fed to solvent tank 127. A vent line 128, which can include a safety-check valve 129, attached to the solvent tank 127 minimizes vapor exposure. Vent gas 191 can exit the solvent tank 127 by vent line 128.

In some embodiments, the solvent tank 127 can be coupled to solvent tank 106 as shown by the dashed arrow. Solvent exiting the solvent tank 127 can travel to the solvent tank 106 via gravimetric drainage. Coupled to the chilled condenser 126 is a vent line 130 through which vent gas 192 can exit the condenser.

Referring back to the flash evaporator 116, components not vaporizing at flash evaporator 116 can travel through an optional filter 119 where it can contact wash solvent from pump 107c. The resulting mixture can be fed to optional flash evaporator 120 via line 121. Line 121 can include an optional heater 131. Insolubles at filter 119 can exit filter 119 via line 122.

The mixture exiting filter 119 can be separated in the optional flash evaporator 120 where the mixture is separated into differently volatile components. A first component can exit the optional flash evaporator 120 via line 132 coupled to line 117. A second component can exit the optional flash evaporator 120 via line 133 and enter a filter 134 where it can contact wash solvent from pump 107c. Insolubles can exit filter 134 via line 135. Solubles can exit filter 134 via line 136 and enter evaporator 118 for separation. Along the line 136 is a heater 137.

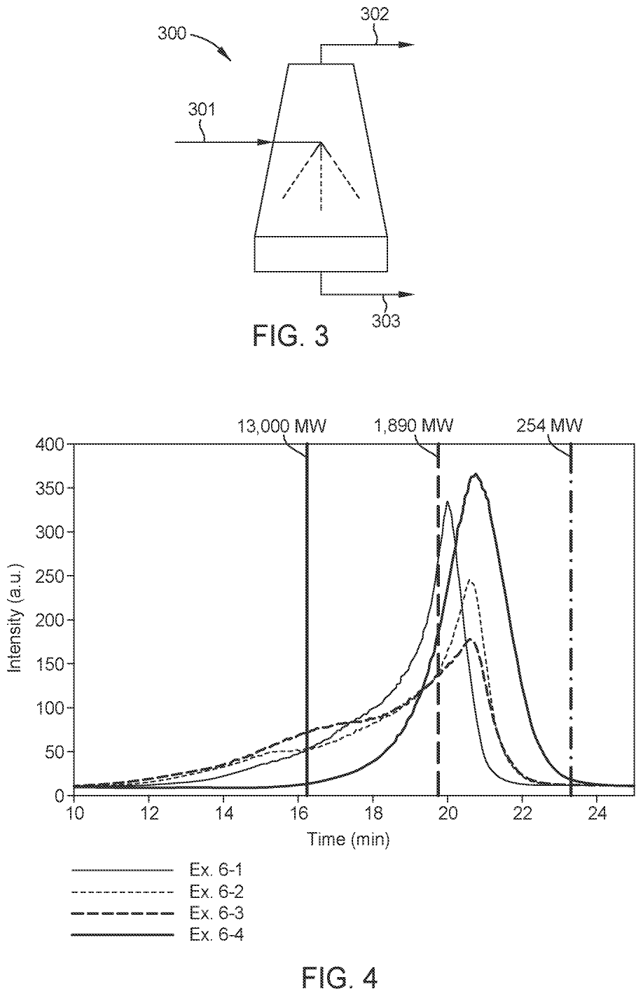

In some embodiments, the solution leaving the extraction reactor 110 is separated into the extracted product and a recycle solvent. An approach for carrying out the separation is shown schematically in FIG. 3, in which the solution enters a separator 300 via line 301 and is flashed in the separator 300 to produce solvent vapor (exiting the separator via line 302) and a relatively low vapor pressure product. This approach is compatible, for example, with a plant wherein the heated, pressurized solution is sprayed into an atmospheric pressure chamber to produce solvent vapor (exiting the separator via line 302) and solid product (exiting the separator via line 303), which includes of small, dry, solid particles.

The solution from the extractor contains a wide range of dissolved coal components with varying degrees of solubility, boiling points, and molecular weights. This can be used to fractionate the extracted product into multiple product streams. In some embodiments, a staged reduction in temperature (resulting in pressure reductions) or partial evaporation of solvent can be used to fractionate the dissolved coal into any number of product streams. A reason for doing this is to improve the properties of the solvent extraction products so that high quality final products can be made and isolated.

Depending on the desired composition, the plant 100 can be designed to produce two or more extraction products from the solution exiting the extraction reactor 110, such as two extraction products, three extraction products, and so forth. The three extraction products can be separated based on, for example, boiling points and use of apparatus such as partial flash evaporators and flash evaporators. Use of multiple flash evaporators can allow for careful control over properties, such as chemical compositions, solubilities, and molecular weights, among others.

In small scale plants, hot materials rapidly cool to ambient temperature unless there is a deliberate attempt to keep the material hot. At large scale, active cooling may be employed to achieve a significant cooling rate, such as by use of indirect heat transfer (heat exchangers) to cool liquids that are simultaneously precipitating solids. Additionally, or alternatively, the pressure of the solution can be dropped, causing a portion of the solvent to flash. This results in concentrating the remaining solution and lowering the temperature of the solution due to the heat of vaporization. Using this method, the plant can be operated to drop the pressure of the solution from the extraction reactor 110 from about 500 psi (3.45 MPa) to about 200 psi (1.38 MPa). Additionally, or alternatively, flash precipitators, flash evaporators, and filtering schemes, such as those described in U.S. Patent Application Publication No. 2022/0177312, can be utilized for separation of product streams.

Apparatus described above can be utilized to extract coal using a solvent comprising alcohol. Processes for treating (or processing) a coal-based feedstock to produce a high value product (a composition described herein) can include contacting a coal-based feedstock with a solvent comprising an alcohol under solvent treatment conditions for generating a soluble phase product and a remainder insoluble phase product; and fractionating the soluble phase product generating at least two fractions under conditions such that at least one of said fractionated products comprises a composition described herein (for example, a high value product).

Implementations can include one or more of the following. The coal-based feedstock can be at least partially derived from coal. The coal-based feedstock can be at least partially derived from subbituminous coal or a derivative thereof. The coal-based feedstock can be generated by thermal treatment of coal or a derivative thereof, such as drying, pyrolysis, heating, or combinations thereof, among others. The coal-based feedstock can be generated by mechanical processing of coal or a derivative thereof such as grinding, pulverizing, sieving, changing particle size, formation of a slurry, or combinations thereof, among others.

As described herein, solvent treatment is useful for separating one or more components of a coal-based feedstock and/or chemically converting components of coal-based feedstock so as to generate useful intermediate, derivative or finished products. In some examples, the solvent can comprise, consist essentially of, or consist of a C4 to C28 monohydric alcohol, a C4 to C28 polyhydric alcohol, or combinations thereof. The solvent can be a pure solvent. The solvent can be a mixed solvent. The solvent can at least partially comprise one or more recycle streams derived from a coal treatment process, a biomass treatment process, a petrochemical process, or combinations thereof.

Selection of the volume of solvent to volume of coal can be beneficial to achieve target yields and to address efficiency. The solvent treatment conditions can include a ratio of a volume of the solvent to a volume of the coal of about 1:1 to about 100:1, such as from about 1:1 to 50:1, such as from about 1:1 to about 20:1, such as from about 1:1 to 10:1, though other ratios are contemplated.

The contacting can comprise extracting the coal-based feedstock with the solvent, chemically reacting the coal-based feedstock with the solvent, or combinations thereof. The contacting can be performed for a duration of about 5 minutes to about 60 hours, such as from about 10 minutes to about 20 hours, such as from about 20 minutes to about 10 hours, such as from about 30 minutes to about 5 hours, though other durations are contemplated. The contacting can be performed at a temperature of about 100° C. or more, such as about 200° C. or more, such as about 300° C. or more, such as from about 300° C. to about 500° C., such as from about 325° C. to about 425° C., such as from about 350° C. to about 400° C., though other temperatures are contemplated. The contacting can be performed at or near (for example, +10%) a temperature at which the solvent boils

The contacting can be performed at a pressure high enough such that the solvent is at least partially a liquid during the contacting. The contacting can be performed at a pressure high enough such that the solvent is at least partially a dense supercritical fluid during the contacting. The contacting can be performed at supercritical fluid conditions. The contacting can be performed using a countercurrent flow. The contacting can be performed using a countercurrent extraction.

The contacting can convert at least 3% by mass of the coal-based feedstock to the soluble phase product, such as about 10% by mass or more, such as about 25% by mass or more, such as about 50% by mass or more, such as about 70% by mass or more, such as about 80% mass or more, such as about 85% by mass or more. The contacting can convert from about 3% to about 95% by mass of the coal-based feedstock to the soluble phase product. The contacting can be performed as a flow through process, a batch process, a co-current process, a counter-current process, or combinations thereof.

The alcohol extract of coal can have any suitable weight average molecular weight. In some embodiments, the alcohol extract of coal can be characterized as having a weight average molecular weight that is from about 50 Daltons (Da) to about 2,000 Da, such as from about 100 Da to about 1,500 Da, such as from about 150 Da to about 1,300 Da, such as from about 250 Da to about 1,100 Da, such as from about 300 Da to about 1,000 Da, such as from about 400 Da to about 900 Da, such as from about 500 Da to about 800 Da, such as from about 600 Da to about 700 Da, though other average molecular weights are contemplated. Any of the foregoing numbers can be used singly to describe an open-ended range or in combination to describe a close-ended range. In at least one example, the alcohol extract of coal can have a weight average molecular weight of about 300 Da to about 2,000 Da. The weight average molecular weight is determined by matrix-assisted laser desorption/ionization (MALDI) mass spectrometry

The C4 to C28 alcohol extract of coal can have a weight average molecular weight that is from about 300 Da to about 2,000 Da as determined by matrix-assisted laser desorption/ionization (MALDI) mass spectrometry. The alcohol extract of coal can have an apparent weight average molecular weight that is from about 300 to about 25,000 Da, such as from about 300 Da to about 13,000 Da, such as from about 350 Da to about 10,000 Da, such as from about 400 Da to about 2,500 Da, though other average molecular weights are contemplated. Any of the foregoing numbers can be used singly to describe an open-ended range or in combination to describe a close-ended range. The apparent weight average molecular weight is determined by size exclusion chromatography.

The alcohol extract of coal can be subject to fractionation. The fractionating of the alcohol extract of coal (if performed) can be achieved by vacuum distillation. Conditions for distillation can be selected such that a vacuum distilled product can be characterized as having a weight average molecular weight that is from about 50 Daltons (Da) to about 2,000 Da, such as from about 100 Da to about 1,500 Da, such as from about 150 Da to about 1,300 Da, such as from about 250 Da to about 1,100 Da, such as from about 300 Da to about 1,000 Da, such as from about 400 Da to about 900 Da, such as from about 500 Da to about 800 Da, such as from about 600 Da to about 700 Da, though other average molecular weights are contemplated. Any of the foregoing numbers can be used singly to describe an open-ended range or in combination to describe a close-ended range. In at least one example, the vacuum distilled product can have a weight average molecular weight of about 300 Da to about 2,000 Da.

The high value product can comprise a non-fuel product. The high value product can comprise a product or precursor thereof, the product or precursor thereof comprising: polymers or polymer precursors; asphaltenic intermediates and/or finished products; asphalt binder; partial replacement of asphalt; recycling agent; anti-stripping agent; crack sealant; sealant for construction; sealant for roofing; coating; adhesive; coal tar; distillates; pitch; bulk asphalt; paving asphalt; graphitic materials; carbon fibers; graphene; building materials; or combinations thereof.

The high value product can comprise polyols, polyurethanes, polyamides, polyesters, epoxy polymers precursors thereof, derivatives thereof, or combinations thereof. The high value product can comprise a non-fuel product, a polymer or polymer precursor, a high value chemical, a composite material, a carbon fiber or a graphene product, a building material, a road material, a paving material, a roofing material, or combinations thereof.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used (for example, amounts, dimensions, et cetera) but some experimental errors and deviations should be accounted for.

### EXAMPLES

Extraction solvents were purchased and used as received. Coal used for the extraction was retrieved from Powder River Basin (Wyoming, USA), from subbituminous coal from the Cordero Rojo mine, and was milled prior to use. Experiments were also performed with lignite coal from Glenrock, Wyoming (USA) operated by Black Hills Bentonite, and was milled prior to use. Milling included crushing and sieving coal and using particles that were at 6.35 mm in size or smaller. In several cases, the coal had a particle size of 0.3-1.7 mm. No difference in extraction was observed when using coal having particle sizes from 2.4 mm to 6.35 mm. Coal was dried in a vacuum oven until the moisture content was at 3.5 wt % or less. Studies with coal up to 25 wt % coal did not show a significant difference in the extraction efficacy, but additional post processing may be performed to remove excess water during the distillation of the products.

### Example 1: Coal Extraction Procedure

Various solvents and extraction parameters were tested, with non-limiting parameters and results shown in Table 1. Coal extraction was performed according to the following non-limiting procedure (with changes depending on the Example investigated).

Milled coal was placed in a Swagelok tube reactor fitted with frits on either side. The tube reactor was placed in an oven maintained at a temperature of about 370° C. The system was purged with nitrogen and pressurized to about 500 psi (about 3.45 MPa) before heating was commenced. A syringe pump was loaded with a specified volume of lauryl alcohol (or other solvent or solvent mixture). Lauryl alcohol flow was commenced at a specified flowrate and continued until the pump reservoir was empty. After passing through, the reactor the solvent was collected in an N₂-pressurized vessel contained outside of the oven. The system was cooled and then depressurized while the solvent containing the extract was recovered. The system was then flushed with acetone and dried with nitrogen. Thereafter, coal remaining in the reactor was collected, washed with acetone, and dried under vacuum at a temperature of about 220° C. under full dynamic vacuum (about 250 mTorr) for about 12 hours. The dried material was weighed to determine the coal extraction percentage.

### Example 2: Distillation Procedure

The coal extraction product was recovered by vacuum distillation of the collected solvent mixture containing both solvent and coal derived compounds termed coal extract. Distillation under vacuum was performed in a distillation apparatus at lab scale (bench scale) or distillation column at pilot scale. At lab scale, the apparatus included a round bottom flask containing the mixture and a stir bar. The round bottom flask was connected to a short path distillation head, which was connected to a collection flask and a high vacuum line.

Heat and mixing were supplied by a magnetic stirrer hotplate with a silicone oil heat bath. The system was argon purged, and then heated to a final temperature of about 250° C. (partial vacuum distillation) or about 300° C. (full vacuum distillation), depending on the desired level of distillation. Final absolute pressure was approximately 0.040 Torr (about 5.33 Pa).

### Example 3: Optional Extended Heating of Lauryl Alcohol (or Other Solvent)

Lauryl alcohol was heated to evaluate its behavior over time at distillation conditions, either in the presence or absence of coal extract. Both pure lauryl alcohol and lauryl alcohol reclaimed from a previous extraction were evaluated. The experimental set-up was the same as that used for distillation. Distilled coal extract and lauryl alcohol were added to the round bottom flask and heated to about 275° C. while being stirred and purged with argon. The mixture was kept at this temperature for about 8 h or about 16 h. The mixture was subsequently vacuum distilled as described above to isolate a product and solvent. Control experiments were conducted as above without the addition of coal extract using both pure and reclaimed lauryl alcohol. Other solvents besides lauryl alcohol can be utilized for the extended heating.

### Example 4: Example Coal Extraction

Table 1 shows non-limiting extraction parameters and results from solvent extraction from milled and dried Cordero Rojo coal. Examples 1-1 through 1-6 were mixtures of 70 vol % C12 (lauryl alcohol) and 30 vol % C14 (myristyl alcohol). Variations of C12 chemistry were also investigated as shown by Examples 1-7, 1-8, and 1-9. 1-dodecene (Example 1-7) is a linear C12 alpha-olefin, lauric aldehyde (Example 1-8) is a linear C12 aldehyde, and lauric acid (Example 1-9) is a linear C12 fatty acid. Stearyl alcohol shown in Example 1-10 is a primary C18 alcohol. Branched alcohols were investigated as shown by Examples 1-11 and 1-12. Exxal 14 (Example 11) is a mixture of C8-C13 isomeric branched primary alcohols commercially available from ExxonMobil, and 2-ethyl-1-hexanol (Example 1-12) is a branched C8 alcohol. Oleyl alcohol (Example 1-13) is a primary C18 alcohol with a single unsaturation, and oleyl amine (Example 1-14) is a primary C18 amine with unsaturation. Examples 1-15 through 1-17 were performed on pre-oxidized coal as such coal can have improved oxidation stability of the coal molecules. Example 1-15 was pre-oxidized at 150° C. for 4 hours with a flow of air under 25 psi pressure, and Example 1-16 was pre-oxidized at 200C for 4 hours with a flow of air under 25 psi pressure. Example 1-17 was pre-oxidized under the same conditions as Example 1-16 but for 8 hours.

TABLE 1
Extraction Data

| | | | | Coal | Coal | | |
|---|---|---|---|---|---|---|---|
| | | Flowrate, | Vol., | starting | extraction, | Temp., | Pressure |
| Example | Solvent | mL/h | mL | weight, g | wt % | ° C. | N₂, psi |
| Ex. 1-1 | Lauryl alcohol | 20 | 90 | 7 | 85 | 370 | 500 |
| Ex. 1-2 | Lauryl alcohol | 20 | 90 | 7 | 86 | 370 | 125 |
| Ex. 1-3 | Lauryl alcohol | 20 | 100 | 7 | 77 | 370 | 500 |
| Ex. 1-4 | Lauryl alcohol | 40 | 200 | 7 | 81 | 370 | 500 |
| Ex. 1-5 | Lauryl alcohol | 80 | 400 | 7 | 81 | 370 | 500 |
| Ex. 1-6 | Dodecane | 20 | 90 | 7 | 2 | 370 | 500 |
| Ex. 1-7 | 1-dodecene | 20 | 90 | 7 | 3 | 370 | 500 |
| Ex. 1-8 | Lauric aldehyde | 20 | 90 | 7 | 70 | 370 | 500 |
| Ex. 1-9 | Lauric acid | 20 | 90 | 7 | 25 | 370 | 500 |
| Ex. 1-10 | Stearyl alcohol | 20 | 90 | 7 | 77 | 370 | 500 |
| Ex. 1-11 | Exxal 14 | 20 | 90 | 7 | 57 | 370 | 500 |
| Ex. 1-12 | 2-ethyl-1-hexanol | 80 | 358 | 7 | 26 | 370 | 500 |
| Ex. 1-13 | Oleyl alcohol | 20 | 100 | 7 | 46 | 370 | 500 |
| Ex. 1-14 | Oleyl amine | 20 | 90 | 7 | 70 | 370 | 500 |
| Ex. 1-15 | Lauryl alcohol | 20 | 90 | 7 | 77 | 370 | 500 |
| Ex. 1-16 | Lauryl alcohol | 20 | 90 | 7 | 73 | 370 | 500 |
| Ex. 1-17 | Lauryl alcohol | 20 | 90 | 7 | 67 | 370 | 500 |

Table 1 shows the solvent extraction conditions using different alcohols, extraction conditions and different pretreatments for the coal. Examples 1-1 and 1-2 indicated that solvent extraction yields are similar at different pressures (125-500 psi). Examples 1-3 to 1-5 indicated that solvent extraction yield are also similar at different flow rates and solvent ratios. Parameters such as residence time and solvent ratio for the solvent extraction can be adjusted. Lower flow rates allows a lower solvent ratio to be used to achieve the same level of extraction, but create more solvent decomposition products (a small amount of alkanes, alkenes, aldehydes, dimer ethers through condensation reactions and a very small amount of alkyl dimers). A higher flow rate and higher solvent ratio can be used to minimize solvent decomposition and to achieve the same level of extraction. Examples 1-7 and 1-8 show the activity of minor decomposition products from the solvent and their potential contribution to the overall extraction process. Example 1-9 indicated that the solvent extraction activity of the fatty acid is significantly lower than the corresponding fatty alcohol. Example 1-10 indicated that using longer chain fatty alcohols, which are most commonly derived from North American vegetable oil sources, such as soybean oil, and tallow are as efficient during solvent extraction as lauryl alcohol. Products from C18 fatty alcohols were softer and more soluble than those from C12 alcohols.

Examples 1-11 and 1-12 indicated that branched alcohols can also be used but their extraction efficiency may be reduced presumably due to beta-elimination reactions in the branched alkyl chain. Example 1-13 shows the extraction using a C18 fatty alcohol with one unsaturated double bond. Here, a single unsaturated double bond can be more desirable than poly-unsaturated alkyl groups because it will be more chemically and oxidative stable. The double bond provides additional solubility/lubricity for the molecules. Example 1-14 shows the extraction with oleyl amine which was found to be more active at extraction than oleyl alcohol. Examples 1-15, 1-16, and 1-17 were extractions performed after pre-oxidation of the coal. These examples show that more severe pre-oxidation can reduce the extraction efficiency. Pre-oxidation can make the solvent extract product less susceptible to changes due to oxidation during asphalt pavement aging conditions.

### Example 5: Characterization of Solvent Extracted Coal

Characterization of example solvent extracted coal was performed on various samples. Solvent extracted coal samples typically include two solubility classes: maltenes (material that is soluble in a low polarity hydrocarbon solvent such as isooctane, pentane, or heptane) and asphaltenes (the insoluble material). Separation of maltenes and asphaltenes into saturate, aromatic, and resin (SAR) fractions was performed as described in U.S. Pat. Nos. 9,353,317 and 10,662,384. SAR-AD (combining Asphaltene Determinator™ (AD) and SAR separation) data is provided in Table 2.

Examples 1-1, 1-10, 1-11, and 1-13 are SAR-AD analysis of residues from solvent extracted coal samples subjected to lab scale, full vacuum distillation as described in Example 2, above. SAR-AD data from coal extraction for Examples 1-1, 1-10, 1-11, and 1-13 were performed using the solvents of lauryl alcohol, stearyl alcohol, Exxal 14, and oleyl alcohol, respectively, to show how the different solvent impact the composition of the extracts. Example 2-1 is a residue from lauryl alcohol-extracted coal sample subjected to scaled-up (17 lbs) solvent extraction with conditions similar to Example 1-2 followed by partial vacuum distillation. Example 2-2 is a residue from lauryl alcohol-extracted coal sample subjected to scaled-up solvent extraction with conditions similar to Example 1-2 but prepared by full vacuum distillation. Example 2-3 is a petroleum asphalt Lloydminster sample for reference. The petroleum asphalt Lloydminster sample is a standard sample produced by the vacuum distillation of Lloydminster crude oil from a petroleum refinery. Example 2-4 is a lauryl alcohol-extracted coal sample subjected to scaled-up solvent extraction similar to Example 1-2 except that the lauryl alcohol distillation and vacuum distillation were done at extended residence times (about 48 hrs) allowing the lauryl alcohol solvent to convert to dimers and other side products.

In Table 2, “Sat” refers to saturates, “Aro 1” refers to molecules that have a single aromatic ring, “Aro 2” refers to molecules with primarily 2-3 aromatic rings and some 4 ring molecules, “Aro 3” refers to molecules with primarily 5+ aromatic rings, Resins refers to aromatic molecules with significant aromatic structures to be brown colored and the presence of heteroatoms, but still soluble in heptane “CyC6” refers to asphaltenes that are insoluble in heptane but soluble in cyclohexane, “Tol.” refers to asphaltenes that are insoluble in heptane and cyclohexane but soluble in toluene, CH₂Cl₂ refers to asphaltenes that are insoluble in heptane, cyclohexane and toluene but are soluble in dichloromethane, total asphaltenes refers to the total of CyC6, Tol., and CH₂Cl₂ fractions present in the asphaltenes. The column labeled “coking” is a measure of how well solubilized/peptized the asphaltenes are in the petroleum sample this is also a measure of the pyrolysis history, and is determined by dividing the CyC6 value by the CH₂Cl₂ value. The column labeled “CII” is a measure of colloidal instability index. CII is determined by Equation 1:

$$( Sat + Aro 1 + Total Asphaltenes ) / ( Aro 2 + Aro 3 + Resins ) \qquad ( Eq . 1 )$$

TABLE 2
SAR-AD Data

| | Maltenes | | | | | | | | | Coking | |
|---|---|---|---|---|---|---|---|---|---|---|---|
| | | Aro | Aro | Aro | | Asphaltenes | | | | CyC6/ | CII |
| Ex. | Sat | 1 | 2 | 3 | Resins | CyC6 | Tol. | CH₂Cl₂ | Total | CH₂Cl₂ | (Eq. 1) |
| Ex. 1-1 | 0.4 | 0.1 | 5.2 | 9.2 | 14.1 | 5.3 | 62.5 | 3.3 | 71.1 | 1.6 | 2.5 |
| Ex. 1-10 | 0.4 | 0.1 | 3.4 | 10.9 | 31.7 | 7.6 | 44.5 | 1.4 | 53.5 | 5.4 | 1.2 |
| Ex. 1-11 | 0 | 0 | 1.6 | 10.6 | 26.3 | 3.6 | 55 | 2.9 | 61.5 | 1.2 | 1.6 |
| Ex. 1-13 | 1.4 | 0.3 | 6.6 | 48.7 | 44.5 | 7.92 | 21.9 | 0.7 | 30.5 | 11.3 | 0.3 |
| Ex. 2-1 | 12.4 | 1.2 | 15.8 | 15.0 | 25.8 | 10.0 | 19.6 | 0.4 | 29.9 | 2.3 | 0.8 |
| Ex. 2-2 | 2.9 | 0.9 | 8.6 | 14.3 | 30.7 | 14.8 | 27.5 | 0.4 | 42.7 | 6.1 | 0.9 |
| Ex. 2-3 | 14.1 | 6.8 | 20.9 | 26.2 | 11.5 | 4.5 | 14.4 | 1.6 | 20.5 | 8.1 | 0.7 |
| Ex. 2-4 | 16.5 | 2.2 | 12.0 | 19.8 | 30.8 | 4.0 | 14.2 | 0.5 | 18.7 | 7.1 | 0.6 |

Table 2 shows the SAR-AD composition for the full vacuum distilled residue of coal solvent extraction products produced from Table 1 (Examples. 1-1, 1-10, 1-11, and 1-13) or from a scaled-up solvent extraction (Examples 2-1 to 2-4). The scaled-up solvent extraction is similar to Example 1 but with 17 lbs of coal.

Example 1-1 compared to Example 1-10 shows similar SAR-AD composition except that Example 1-10 that was prepared with stearyl alcohol has less over all asphaltenes. It was determined that the longer alkyl chains in stearyl alcohol relative to lauryl alcohol cause more soluble molecules (maltenes) to be produced. It was also determined that branched alcohols (Exxal 13, Example 1-11) can increase the solubility of produced solvent extract. Relative to lauryl alcohol (Example 1-1), less asphaltenes were produced and more maltenes, especially the Resins fraction were produced. Adding a double bond to C18 alkyl chains, as in the case of oleyl alcohol (Example 1-13), also increased the solubility further compared to C18 fully saturate alkyl chains in Example 1-10. This is shown by Example 1-13 having more maltenes, but in particular a shift to significantly more Aro 3 and Resins relative to Example 1-10.

An increase in the maltenes fraction generally produces products that have a lower melting point, softening point and viscosity as long as the molecular weights and chemistries are about the same. Examples 2-1, 2-2, 2-3, and 2-4 show that the product quality from scaled-up solvent extraction can be tuned by changing the distillation conditions. A partial vacuum distillation as described above creates a product Example 2-1 that looks similar in composition to a petroleum asphalt, Example 2-3. Cordero Rojo coal, and its solvent extraction, does not produce many Saturates. The Saturates shown in Example 2-1 are a product of the thermal induced reaction of lauryl alcohol with itself to produce longer alkyl chains, and especially ethers through condensation reaction and a minor fraction of esters and other self-reacted products. These products are generically referred to as dimers. Full vacuum distillation removes more of the dimers and thereby reducing the amount of Saturates, as shown in Example 2-2. Example 2-4 shows how the product changes with extended heating times during the distillation process. Example 2-4 was a partial vacuum distillation like Example 2-1, but with a residence time 4 times longer during the distillation process which continued to accelerate the formation of dimers and other lauryl alcohol self-reaction products, and also by the continued reaction of lauryl alcohol at the coal molecules. This result is indicated by, for example, the larger amount of Saturates (lauryl alcohol self-reaction) and larger amount of Aro 3 and Resins (reaction at coal molecules) compared to Example 2-1. These examples show how the solvent and processing conditions can be used to tune the composition of the produced extracts.

Viscosity and ring and ball softening points of various solvent extracted coal samples were measured using an Anton Paar dynamic shear rheometer. Non-limiting results are shown in Table 3 and compared to typical unaged non-polymer modified asphalt values. Example 2-1 is a residue from lauryl alcohol-extracted coal sample subjected to scaled-up solvent extraction, partial vacuum distillation as described above. Example 2-2 is a residue from lauryl alcohol-extracted coal sample subjected to scaled-up solvent extraction, full vacuum distillation as described above. The normal petroleum asphalt range is various paving grade asphalts and utilized as a comparative. Superpave (Superior Performing Asphalt Pavements) are petroleum asphalt and used as a comparative. Ring and ball softening points were determined using ASTM D36.

TABLE 3
Viscosity and Ring and Ball Softening Point
for Asphalt-like Coal Solvent Extracts

| | Viscosity | Viscosity | Viscosity | Ring and ball |
|---|---|---|---|---|
| | at 135° C., | at 150° C., | at 170° C., | softening point, |
| Example | Pa · s | Pa · s | Pa · s | ° C. |
| Ex. 2-1 | 1.16 | 0.51 | 0.23 | 60 |
| Ex. 2-2 | 25.91 | 0.82 | 0.59 | 142 |
| Normal petroleum | 0.2-2.0 | — | — | 35-60 |
| asphalt range | | | | |
| (comparative) | | | | |
| Superpave | 3 or less | — | — | — |
| (petroleum asphalt) | | | | |

The data shown in Table 3 indicated that, when using a partial vacuum distillation of scaled-up solvent extraction products produced from coal lauryl alcohol solvent extracts, give viscosity at 135° C. and ring and ball softening points that are within the normal range for paving grade, unaged and non-polymer modified asphalt. A harder product can be produced by the full vacuum distillation procedure which produces product that are within the viscosity range for roofing asphalts.

### Example 6: Asphalt Blends

Asphalt blends (or bitumen blends) were prepared to show the behavior of the solvent extract under standard paving testing, to show compatibility between petroleum asphalt and the solvent extracts, and how the coal extracts can be used to extend petroleum asphalt supplies. Low temperature properties were determined according to 4-mm DSR (TechBrief, FHWA Publication No. FHWA-HRT-15-053, July 2017). USAT aging was determined according to TechBrief, FHWA Publication No. FHWA-HRT-15-053, July 2017. Rolling thin film oven aging was done according to American Association of State Highway and Transportation Officials (AASHTO) T 240, using a Pressurized Aging Vessel (AASHTO R 28), and Determining the Rheological Properties of Asphalt Binder Using a Dynamic Shear Rheometer (DSR) AASHTO T 315.

The asphalt blends were made using a Wyoming paving grade asphalt (Holly Frontier PG 58-28, BI-0003), a Strategic Highway Research Program asphalt from Lloydminster crude oil (PG 58-28, AAA-1), or a poorly oxidizing and high wax asphalt from a West Texas Sour crude oil (PG 64-10, AAF-1). Chemical and physical properties of AAA-1 can be found at David R. Jones, SHRP-A-645, SHRP Materials Reference Library: Asphalt Cements: A Concise Data Compilation, May 1993.

Certain asphalt blends included the partially distilled residue solvent extract (Example 2-1) or the fully distilled residue solvent extract (Example 2-2) as shown in Table 4. Example 4-1 includes example asphalt blends of BI-0003 and solvent extract Ex. 2-1 or solvent extract Ex. 2-2 at various proportions. Example 4-2 includes example asphalt blends of AAA-1 and solvent extract Ex. 2-1 at various proportions. Example 4-3 includes example asphalt blends of AAF-1 and solvent extract Ex. 2-1 or solvent extract Ex. 2-2 at various proportions. Table 4 shows non-limiting properties graded according to AASHTO M320 or ASTM D6373. In Table 4, “unaged” refers to the native state of the solvent extracts with no oxidative conditioning, “upper PG” refers to the upper temperature performance grade according to Superpave specifications as outlined in AASHTO T 315 using a dynamic shear rheometer (DSR), “USAT RTFO/PAV” refers to aging according to FHWA Tech Brief FHWA-HRT-15-054 for the Universal Simple Aging Test, “Tc (m-value)” and “Tc(S)” refer to the critical temperatures for the rate of relaxation and stiffness, respectively, according to FHWA Tech Brief FHWA-HRT-15-053 using 4 mm parallel plate DSR.

TABLE 4

| | | | | Properties graded | | |
|---|---|---|---|---|---|---|
| | | | | | Low temperature, USAT | |
| | Asphalt blend | | | | RTFO/PAV | |
| | wt % of | wt % of | | Unaged | Tc(m- | |
| | petroleum | solvent | Solvent | Upper | value), | Tc(S), |
| Example | asphalt | extract | extract | PG, ° C. | ° C. | ° C. |
| Ex. 4-1 | 100 | 0 | Ex. 2-1 | 63.3 | −18.7 | −21.8 |
| | 95 | 5 | Ex. 2-1 | 63.2 | −20.6 | Below −30 |
| | 90 | 10 | Ex. 2-1 | 62.9 | −16.9 | Below −30 |
| | 85 | 15 | Ex. 2-1 | 62 | −16 | Below −30 |
| | 75 | 25 | Ex. 2-1 | 61.8 | −15 | Below −30 |
| | 95 | 5 | Ex. 2-2 | 64.5 | −21 | −29.9 |
| | 90 | 10 | Ex. 2-2 | 68.8 | −13.5 | −25.1 |
| | 85 | 15 | Ex. 2-2 | 73.2 | −8.8 | — |
| Ex. 4-2 | 100 | 0 | Ex. 2-1 | 61.9 | −23.4 | −24.1 |
| | 90 | 10 | Ex. 2-1 | 60.1 | Below −30 | Below −30 |
| | 85 | 15 | Ex. 2-1 | 62.1 | Below −30 | Below −30 |
| | 75 | 25 | Ex. 2-1 | 58.5 | Below −30 | Below −30 |
| Ex. 4-3 | 100 | 0 | Ex. 2-1 | 64.7 | −10.5 | −18.3 |
| | 85 | 15 | Ex. 2-1 | 64.3 | −7.8 | −21 |
| | 75 | 25 | Ex. 2-1 | 62.2 | −10 | −22.5 |
| | 85 | 15 | Ex. 2-2 | 72.9 | −5.5 | −14.4 |

As described above, BI-0003, AAA-1 and AAF-1 were base petroleum asphalts that were blended with selected solvent extracts (coal-based asphalts). These tests were performed to help understand the performance of the coal extracts in petroleum asphalt according to petroleum asphalt specifications, to determine the compatibility of the solvent extracts (coal-based asphalt) with petroleum asphalt, and to test the coal-based asphalt as an extender (partial low carbon/carbon negative replacement) for use with petroleum asphalt. The asphalt blends of Example 4-1 that included lauryl alcohol-extracted coal sample subjected to scaled-up solvent extraction, partial vacuum distillation (Ex. 2-1) showed softening as indicated by the decrease in the upper PG. The asphalt blends of Example 4-1 that included lauryl alcohol-extracted coal sample subjected to scaled-up solvent extraction, full vacuum distillation (Ex. 2-2) showed stiffening relative to conventional asphalt blends as indicated by the increase in the upper PG.

Low temperature Tc(S) values for the asphalt blends indicated that the blends with partial vacuum distillation solvent extracts also softened at the low temperature resulting in more negative temperatures with increasing concentration. The Tc (m-value) values showed a decrease for AAA-1, some increase for BI-0003, and nearly no change for AAF-1. This dependence of Tc (m-value) on the asphalt source (crude oil source) shows that the improvement (the decrease) in the low temperature PG can be linked to the source and chemistry of the petroleum asphalt binder. The large upper PG stiffening effect observed for the blends containing the full vacuum distillation solvent extracts is also reflected in the increase in the low temperature Tc (m-value) and Tc(S) values with increasing amount of coal extract, especially when compared to blends with the same amount of the partial vacuum distillation product.

### Example 7: Polymer-Modified Solvent Extracted Coal

Properties of polymer-modified solvent extracted coal samples were also investigated. Here, residues from lauryl alcohol-extracted coal sample subjected to scaled-up solvent extraction, partial vacuum distillation were physically blended with 3 wt % styrene-butadiene-styrene (SBS) polymer Kraton D0243. Multiple Stress Creep Recovery (MSCR) properties were measured according to TechBrief, FHWA-HIF-11-038, ASTM D7405, AASHTO TP 70 using the RTFO residue and testing at 64° C. (AASHTO T 240 and ASTM D 2872: Effect of Heat and Air on a Moving Film of Asphalt (Rolling Thin-Film Oven Test)).

Table 5 shows non-limiting results. Example 2-4 is lauryl alcohol-extracted coal sample subjected to scaled-up solvent extraction, partial vacuum distillation without SBS polymer. Examples 5-1 and 5-2 are both 3% SBS blends with Example 2-4, with Example 5-1 subjected to stirring conditions and Example 5-2 subjected to high shear conditions. In Table 5, “Jnr” refers to non-recoverable creep compliance for N, where N is the residual strain in a specimen after creep and recovery cycle divided by the stress applied at 3.2 kPa. “% difference” refers to the percent difference in the recovery between 0.1000 kPa and 3.2000 kPa.

TABLE 5
MSCR data for the partially vacuum distilled solvent
extract with and without SBS polymer modification

| | | | | % recoverable | % non- |
|---|---|---|---|---|---|
| | Upper | Jnr @@3.2 | % | strain @3.2 | recoverable strain |
| Example | PG, ° C. | kpa, kPa⁻¹ | difference | kPa, % | @3.2 kPa, % |
| Ex. 2-4 | 88 | 2.46300 | 203.8 | 5.4 | 94.6 |
| Ex. 5-1 | — | 0.07206 | 80.1 | 60.7 | 39.3 |
| Ex. 5-2 | 138.4 | −0.00265 | −30.4 | 115.9 | −15.9 |

During polymer modification, as the polymer becomes more compatible with the asphalt and more dispersed, the polymer network can be more active at changing the properties of the asphalt, especially in the case of SBS polymer modified asphalts. The MSCR test gives data particularly useful for rutting resistance through the non-recoverable creep compliance (Jnr) measured at 3.2 kPa at 64° C., and for detecting and quantifying the presence of elastic response and stress dependence for the binder and especially polymer modification through the percent recovery. A higher Jnr @ 3.2 kPa⁻¹ will result in a higher level of rutting. A Jnr @ 3.2 kPa⁻¹ for the partially distilled solvent extract would give a standard traffic grade.

The data indicates that polymer modification significantly increases the stiffness of the blend as shown by the substantial decrease in the Jnr @ 3.2 kPa⁻¹. Continued blending with a high shear mixer further reduced the Jnr @ 3.2 kPa⁻¹ and also significantly increased the upper temperature PG. The % recoverable strain also increased significantly when blending with SBS polymer which further increased with shear mixing so that all of the delated elastic effects are recovered when using high shear mixing to incorporate the polymer.

### Example 8: Size Exclusion Chromatography

Size exclusion chromatography (SEC) was also performed on various samples using an evaporative light scattering detector (ELSD). An Agilent HPLC was fitted with 10,000 Å and 1,000 Å SEC columns (Phenomenex). The mobile phase was THF. Samples were prepared at 2% (wt/vol). 7.5 μL aliquots were injected. The flowrate was 1 mL/min and oven temperature 30° C.

Exemplary, but non-limiting, SEC data is shown in FIG. 4. Example 6-1 is fully distilled solvent extract Example 1-10. Example 6-2 is similar to fully distilled solvent extract Example 1-1, but it is heated with the solvent during the work-up and resulted in a softer material due to continued reaction with the lauryl alcohol. Example 6-3 is fully distilled solvent extract Example 1-1. Example 6-4 is paving grade petroleum asphalt BI-0003 as described above. Overall, the major peak of Example 6-1 (stearyl alcohol coal extract) has a large molecular weight peak. It was noted that, while Examples 6-2 and Example 6-3 are lauryl alcohol coal extracts, Example 6-2 was a softer material than Example 6-3. Here, the Metler Toledo Dropping Point Apparatus Softening Point of Examples 6-2 and 6-3 were determined to be 194.9° C. and 244.8° C., respectively.

With reference to FIG. 4, the SEC chromatograms material below about 18 minutes indicate mainly associated molecular species in the form of asphaltenes. Material above 18 minutes are mainly free molecules and represent maltenes. These results are consistent with the SAR-AD data. A higher amount of molecular associations indicates that there are specific molecular interactions. The solvent extracts products have more asphaltenes and more associations (for example, more higher MW/lower retention time material) than a typical petroleum asphalt (BI-0003). When using comparing stearyl alcohol coal extract (Example 6-1) to lauryl alcohol coal extracts (Examples 6-2 and 6-3), the peak of the maltenes fraction for stearyl alcohol coal extract is shifted to lower retention times, or higher molecular weights, indicating successful modification of the molecules with large C18 groups relative to C12 groups. A similar type of transition for the peak of the asphaltenes fraction is also observed. When compared to the maltenes of BI-0003, the lauryl alcohol coal extract product peak is within the range of MW for petroleum asphalt. For the stearyl alcohol coal extract (Example 6-1) it is slightly higher, but still within the range of other asphalts (not shown).

### Example 9: Fuels

Use of the composition in a low-sulfur marine fuel was also investigated. Table 6 shows selected properties of example solvent extracted coal samples. In Table 6, “HHV” refers to higher heating value.

TABLE 6

| | | Hydro- | Nitro- | | | |
|---|---|---|---|---|---|---|
| Solvent | Carbon, | gen, | gen, | Oxygen, | Sulfur, | HHV, |
| extract | % w/w | % w/w | % w/w | % w/w | % w/w | BTU/lb |
| Ex. 1-1 | 82.09 | 9.36 | 0.71 | 7.24 | 0.19 | 16,300 |
| Ex. 1-10 | 82.60 | 9.83 | 0.57 | 5.93 | 0.17 | 16,800 |

The data indicates that atom content and HHV can be varied by choice of solvent utilized for the solvent extraction. For example, the use of octadecanol (Ex. 1-10) as solvent can add longer alkyl groups to the coal extract molecules giving it a higher hydrogen/carbon and a lower heteroatom content. The densities of the solvent extracts of coal were determined to be about 0.95 g/mL which is similar to heavy marine fuel oils. HHV was determined to be in the range of about 135,000 btu/gallon to about 139,000 btu/gallon, which is similar to a FAME fuel.

Blends were made with Ex. 1-1 and Ex. 1-10 and they are soluble in fatty acid methyl ester (FAME) at 1:1 blend ratios. These blend ratios can be adjusted to tune the density, viscosity, or other properties for which class of fuel is desired. The very low sulfur contents (less than 0.2% w/w) is compatible with International Maritime Organization 2020 standards. If waste coal (fines/tailing) is used, embodiments described herein can be used to clean up the environment and utilize low-rank waste coal as a high value fuel feedstock. Overall, the data indicates that solvent extracts of coal can be utilized as fuels such as marine fuel oils.

### Embodiments Listing

The present disclosure provides, among others, the following embodiments, each of which can be considered as optionally including any alternate embodiments:

Clause A1. A composition, comprising a C4 to C28 alcohol extract of coal.

Clause A2. The composition of Clause A1, wherein the C4 to C28 alcohol comprises, a linear or branched, saturated or unsaturated, C8 to C24 alcohol.

Clause A3. The composition of Clause A1 or Clause A2, wherein the C4 to C28 alcohol comprises lauryl alcohol, myristyl alcohol, stearyl alcohol, cetyl alcohol, oleyl alcohol, linoleic alcohol, isostearyl alcohol, cardanol, or combinations thereof.

Clause A4. The composition of any one of Clauses A1-A3, wherein the C4 to C28 extract of coal is at least partially vacuum distilled.

Clause A5. The composition of any one of Clauses A1-A4, further comprising a polymer derived from a C4 to C28 alcohol monomer.

Clause A6. The composition of Clause A5, wherein the polymer comprises a dimer, the dimer comprising an ether.

Clause A7. The composition of any one of Clauses A1-A6, wherein the C4 to C28 alcohol monomer comprises an internal olefin.

Clause A8. The composition of any one of Clauses A1-A7, wherein the C4 to C28 alcohol extract of coal has:
an apparent weight average molecular weight that is from about 300 Da to about 25,000 Da as determined by size exclusion chromatography;
weight average molecular weight that is from about 300 Da to about 300 Da to about 2,000 Da; or
combinations thereof.

Clause A9. A solvent extracted material for use as an asphalt replacement, comprising the composition of any one of Clauses A1-A8.

Clause A10. The solvent extracted material of Clause A9, further comprising a vegetable oil, an animal oil, an aromatic oil, a paraffin oil, or combinations thereof.

Clause A11. An asphalt or bitumen composition that resists flow at ambient temperature, comprising the composition of any one of Clauses A1-A10.

Clause A12. An asphalt or bitumen composition that is solid at ambient temperature, comprising the composition of any one of Clauses A1-A10.

Clause A13. A fuel comprising the composition of any one of Clauses A1-A8.

Clause A14. The fuel of Clause A13, further comprising biodiesel, renewable diesel, bio-oils, pyrolysis oils from biomass, oils from depolymerization of waste, pyrolysis oils from wastes, bunker fuels, bunker crudes, heavy fuel oil, marine fuel oil, upgraded petroleum fuels, catalytically upgrade petroleum fuels, heavy oils, petroleum residues, or combinations thereof.

Clause A15. A marine fuel oil comprising the fuel of Clause A13 or Clause A14.

Clause B1. A blend comprising:
a C4 to C28 alcohol extract of coal; and
a polymer derived from a monomer comprising styrene, butadiene, isoprene, ethylene, propylene, vinyl chloride, methyl acrylate, vinylacetate, chloroprene, isocyanate, amide, ester, or combinations thereof.

Clause B2. The blend of Clause B1, wherein the monomer comprises styrene, butadiene, or combinations thereof.

Clause B3. A pavement formulation, comprising: the blend of Clause B1 or Clause B2; and an oil.

Clause B4. The pavement formulation of Clause B3, wherein the oil comprises a vegetable oil, an animal oil, an aromatic oil, a paraffin oil, re-refined engine oil bottoms, a vacuum tower asphalt extender, a component thereof, or combinations thereof.

Clause B5. A crack sealant for asphalt or concrete, the crack sealant comprising the blend of any one of Clauses B1-B4.

Clause B6. A shingle coating, comprising the blend of any one of Clauses B1-B5, wherein the C4 to C28 alcohol extract of coal is at least partially vacuum distilled.

Clause B7. A sealant comprising the blend of any one of Clauses B1-B6.

Clause B8. An adhesive comprising blend of any one of Clauses B1-B7.

Clause C1. A composition, comprising: a reaction product of a C4 to C28 alcohol extract of coal with an amine, a carboxylic acid, or combinations thereof.

Clause C2. A pavement formulation, comprising:
the composition of Clause C1; and
recuperated asphalt pavement, reclaimed asphalt pavement, asphalt products, reclaimed asphalt products, fresh asphalt, bituminous products, reclaimed bituminous products, fresh bitumen, or combinations thereof.

Clause C3. An anti-stripping agent comprising the composition of Clause C1 or Clause C2.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, process operation, process operations, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, process operation, process operations, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

References cited herein are incorporated by reference herein in their entirety to indicate the state of the art as of their publication or filing date and it is intended that this information can be employed herein, if needed, to exclude specific embodiments that are in the prior art.

As used herein, the indefinite article “a” or “an” shall mean “at least one” unless specified to the contrary or the context clearly indicates otherwise. For example, embodiments comprising “a solvent” include embodiments comprising one, two, or more solvents, unless specified to the contrary or the context clearly indicates only one solvent is included.

While the foregoing is directed to embodiments of the present disclosure, other and further embodiments of the disclosure may be devised without departing from the basic scope thereof, and the scope thereof is determined by the claims that follow.

What is claimed is:

1. A composition, comprising:
a C4 to C28 alcohol extract of coal.

2. The composition of claim 1, wherein the C4 to C28 alcohol comprises a linear or branched, saturated or unsaturated, cyclic or acyclic, aromatic or nonaromatic C4 to C28 alcohol.

3. The composition of claim 1, wherein the C4 to C28 alcohol comprises lauryl alcohol, myristyl alcohol, stearyl alcohol, cetyl alcohol, oleyl alcohol, linoleic alcohol, isostearyl alcohol, cardanol, or combinations thereof.

4. The composition of claim 1, wherein the C4 to C28 extract of coal is at least partially vacuum distilled.

5. The composition of claim 1, further comprising a polymer derived from a C4 to C28 alcohol monomer.

6. The composition of claim 5, wherein the polymer comprises a dimer, the dimer comprising an ether.

7. The composition of claim 1, wherein the C4 to C28 alcohol monomer comprises an internal olefin.

8. The composition of claim 1, wherein the C4 to C28 alcohol extract of coal has:
an apparent weight average molecular weight that is from about 300 Da to about 25,000 Da as determined by size exclusion chromatography;
weight average molecular weight that is from about 300 Da to about 300 Da to about 2,000 Da; or
combinations thereof.

9. A solvent extracted material for use as an asphalt replacement, comprising:
the composition of claim 1.

10. The solvent extracted material of claim 9, further comprising a vegetable oil, an animal oil, an aromatic oil, a paraffin oil, or combinations thereof.

11. An asphalt or bitumen composition that resists flow at ambient temperature, comprising:
the composition of claim 1.

12. A blend comprising:
a C4 to C28 alcohol extract of coal; and
a polymer derived from a monomer comprising styrene, butadiene, isoprene, ethylene, propylene, vinyl chloride, methyl acrylate, vinylacetate, chloroprene, isocyanate, amide, ester, or combinations thereof.

13. The blend of claim 12, wherein the monomer comprises styrene, butadiene, or combinations thereof.

14. A pavement formulation, comprising:
the blend of claim 12; and
an oil comprising a vegetable oil, an animal oil, an aromatic oil, a paraffin oil, re-refined engine oil bottoms, a vacuum tower asphalt extender, a component thereof, or combinations thereof.

15. A crack sealant for asphalt or concrete, the crack sealant comprising the blend of claim 12.

16. A shingle coating, comprising:
the blend of claim 12, wherein the C4 to C28 alcohol extract of coal is at least partially vacuum distilled.

17. A sealant or an adhesive comprising the blend of claim 12.

18. A composition, comprising:
a reaction product of a C4 to C28 alcohol extract of coal with an amine, a carboxylic acid, an acid chloride, or combinations thereof.

19. A pavement formulation, comprising:
the composition of claim 18; and
recuperated asphalt pavement, reclaimed asphalt pavement, asphalt products, reclaimed asphalt products, fresh asphalt, bituminous products, reclaimed bituminous products, fresh bitumen, or combinations thereof.

20. An anti-stripping agent comprising the composition of claim 18.
